(19) United States
(12) Patent Application Publication
(10) Pub. No.: US 2026/0319717 A1
(43) Pub. Date: Oct. 15, 2026

(54) PRINTING APPARATUS

(71) Applicant: BROTHER KOGYO KABUSHIKI KAISHA, Nagoya (JP)

(72) Inventor: Yutaka URAKAWA, Nagoya (JP)

(73) Assignee: BROTHER KOGYO KABUSHIKI KAISHA, Nagoya (JP)

(21) Appl. No.: 19/568,010

(22) Filed: Mar. 16, 2026

(30) Foreign Application Priority Data
Apr. 9, 2025 (JP) 2025-064346

(51) Int. Cl. G06F 3/12; G06F 3/0482

(52) U.S. Cl. CPC G06F 3/1207; G06F 3/1204; G06F 3/1255; G06F 3/1259; G06F 3/0482; G06F 3/1274; G06F 3/1286

(57) ABSTRACT

A printing apparatus includes a user interface, and a controller. In response to a cancellation instruction related to a print job associated with a user being input to the controller via the user interface, the controller causes the user interface to display a warning in a case where the cancellation instruction does not correspond to the user associated with the print job.

### REFERENCE TO RELATED APPLICATIONS

This application claims priority from Japanese Patent Application No. 2025-064346 filed on Apr. 9, 2025. The entire content of the priority application is incorporated herein by reference.

### BACKGROUND ART

A known printing apparatus stores a received print job in a memory and then performs storage printing of the stored print job in response to a user logging in.

### SUMMARY

However, in the above-described known printing apparatus, the print job for the storage printing might be canceled by a person other than the user who has transmitted the print job, for example, by an operator currently operating the printing apparatus.

The present disclosure aims to provide a technique of restricting cancellation of a print job for the storage printing by the person other than the user.

A printing apparatus according to an aspect of the present disclosure includes: a user interface; and a controller. In response to a cancellation instruction related to a print job associated with a user being input to the controller via the user interface, the controller is configured to cause the user interface to display a warning in a case where the cancellation instruction does not correspond to the user associated with the print job.

The printing apparatus according to the aspect of the present disclosure is capable of restricting the cancellation of the print job for the storage printing by the person other than the user.

### BRIEF DESCRIPTION OF DRAWINGS

FIG. 1 is a diagram illustrating the configuration of an image forming system.

FIG. 2 is a flowchart illustrating an example of the procedure wherein a PC obtains secure function lock settings screen data from an MFP.

FIGS. 3A to 3C are views illustrating an example of changes in a secure function lock settings screen.

FIGS. 4A and 4B are a flowchart illustrating a procedure of the receiving and printing process.

FIG. 5 is a flowchart illustrating the continuation of the procedure of the receiving and printing process in FIGS. 4A and 4B.

FIGS. 6A and 6B are a flowchart illustrating the procedure of a user I/F operation process.

FIG. 7 is a flowchart illustrating the procedure of a cancel key pressing process.

FIGS. 8A and 8B are a flowchart illustrating the procedure of a displaying process.

FIGS. 9A and 9B are a flowchart illustrating the continuation of the procedure of the displaying process in FIGS. 8A and 8B.

FIG. 10 is a flowchart illustrating the procedure of a login process.

FIGS. 11A and 11B are a flowchart illustrating the procedure of the continuation of the login process in FIG. 10.

FIG. 12A to FIG. 12D are diagrams illustrating an example of changes in the state of a user interface, in accordance with the changes in the internal state of the MFP.

FIGS. 13A to 13D are diagrams illustrating an example of changes in the state of a user interface, different from FIGS. 12A to 12D.

FIG. 14A to FIG. 14C are diagrams illustrating an example of changes in the state of a user interface, different from FIGS. 13A to 13D.

FIG. 15A and FIG. 15B are diagrams illustrating an example of changes in the state of a user I/F different from FIGS. 14A to 14C.

FIGS. 16A to 16C are examples illustrating various kinds of data stored in a memory of the MFP.

FIG. 17 is a diagram illustrating an example of the data structure of a print job.

FIG. 18 is a flowchart illustrating an example of a procedure for printing an MFP report from the MFP.

### DESCRIPTION

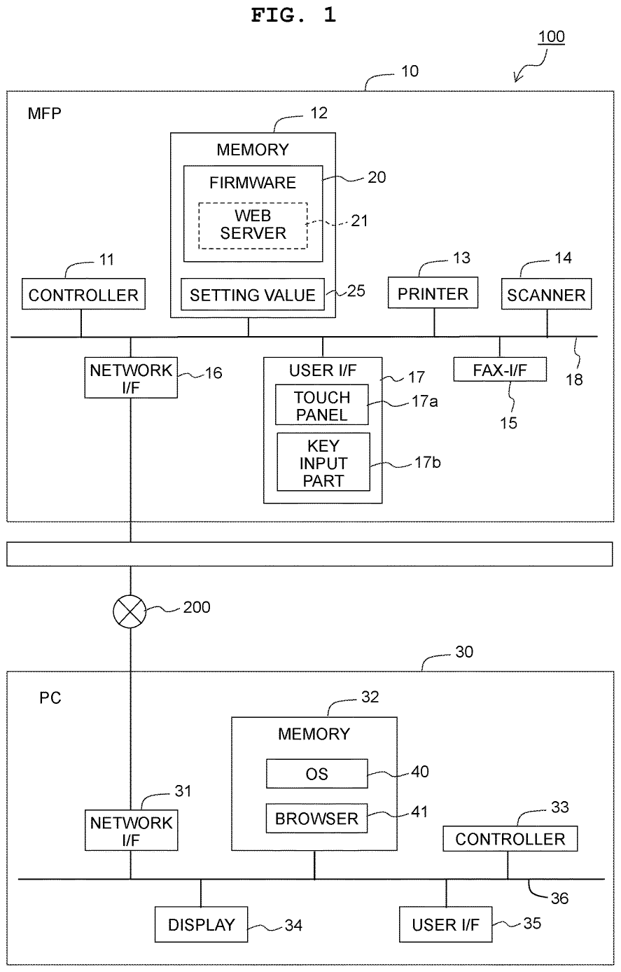

An image forming system 100 related to an embodiment of the present disclosure will be described below, with reference to the drawings. The image forming system 100 illustrated in FIG. 1 includes an MFP (abbreviation for “multi-function peripheral”) 10 and a PC 30. The MFP 10 and the PC 30 are connected to a network 200 and can communicate via the network 200. The network 200 is a LAN or the Internet. In the present embodiment, the MFP 10 is an example of a printing apparatus.

The MFP 10 includes a controller 11, a memory 12, a printer 13, a scanner 14, a fax-I/F 15, a network I/F 16, a user I/F 17, and a bus 18. The term “I/F” is an abbreviation for an interface. The network I/F 16 connects the MFP 10 to the network 200 in accordance with a predetermined network protocol. The user I/F 17 is an interface interposed between a user directly operating the MFP 10 and the controller 11. The user I/F 17 includes a touch panel 17a and a key input part 17b. The key input part 17b is constructed of a plurality of keys, which are, for example, three keys. For example, the user can operate a certain key, of the plurality of keys, so as to switch a backlight between the on and off states. The printer 13 performs a printing operation of printing an image on a recording medium, such as a sheet or a disk. For example, an electrophotographic system, the ink-jet system, etc., may be adopted as the recording system of the printer 13. The scanner 14 performs a scanning operation of reading an image recorded on an original and generating image data of the read image. The fax-I/F 15 performs a fax operation of transmitting and receiving image data in a system conforming to the fax protocol. Further, the MFP 10 may be capable of performing a composite operation of combining a plurality of operations. A copying operation of combining the printing operation by the printer 13 and the scanning operation by the scanner 14 is an example of the composite operation.

The Controller 11 is constructed, for example, of a CPU and ASIC (Application Specific Integrated Circuits), etc., and controls the operation of each of the printer 13, the scanner 14, the fax-I/F 15, the network I/F 16, and the user I/F 17. The memory 12 includes a data storage region. The data storage region is a region which stores data necessary for executing a program, etc. The memory 12 is constructed by combining RAM, ROM, SSD, HDD, etc. A buffer included in the controller 11 and used in a case where various programs are executed may also be considered a part of the memory 12. Further, the memory 12 may be a storage medium which is readable by the controller 11. The storage medium readable by controller 11 is a non-transitory medium. In addition to the above-described examples, the non-transitory medium also includes a storage medium such as a CD-ROM and a DVD-ROM. Further, the non-transitory medium is also a tangible medium. On the other hand, electrical signals which carry a program downloaded, for example, from a server on the Internet are a computer-readable signal medium which is a kind of a computer-readable medium, but is not included in the non-transitory and computer-readable storage medium.

The memory 12 stores firmware 20 as a program executable by the controller 11. In the following description, the processes such as “determination”, “extraction”, “selection”, “calculation”, “decision”, “specification”, “obtainment”, “reception”, and “control” represent the processes performed by the controller 11 in accordance with instructions described in a program. Note that the “obtainment” is used as a concept which does not require a request. That is, the process in which the controller 11 receives data without requesting the data is also included in the concept of “the controller 11 obtains data”. Further, the term “data” in the present specification is represented by a computer-readable bit string. Furthermore, a plurality of pieces of data which are substantially the same meaning but have different formats shall be treated as being mutually same. The same applies also to the term “information” in the present specification.

The firmware 20 also functions as a web server 21 configured to display a predetermined web page with respect to the PC 30. That is, the firmware 20 functions also as an EWS (Embedded Web Server). The Web server 21 is capable of transmitting data for displaying a Web page to the PC 30 to thereby provide the Web page to a browser 41, of the PC 30, which will be described later. As will be described later, the MFP 10 is capable of accepting an operation by the user via the Web page provided to the PC 30. That is, the Web server 21 is an example of a user interface.

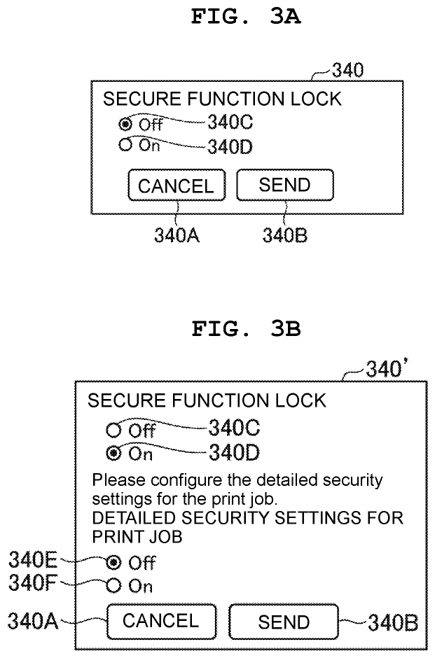

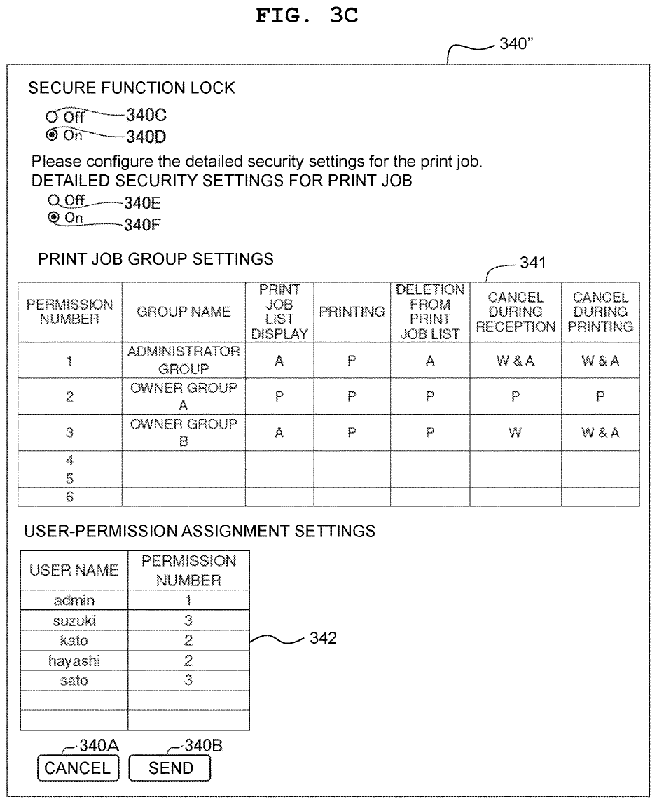

Further, the memory 12 stores a setting value 25. Although the term is referred to as the “setting value 25” for the sake of convenience, the setting value 25 includes a large number of setting values. The MFP 10 performs various operation processes based on the setting value 25. For example, the MFP 10 is capable of performing a communication using the network I/F 16, in accordance with a setting value related to the network and included in the setting value 25. Furthermore, the setting value 25 includes a setting value of secure function lock. The secure function lock is a function with which various operations of the MFP 10 can be restricted for each of a plurality of users. In the present embodiment, the operations which can be restricted by the secure function lock will be described in detail later based on FIG. 3.

Next, the configuration of the PC 30 will be described. The PC 30 includes a network I/F 31, a memory 32, a controller 33, a display 34, and a user I/F 35. The network I/F 31, the memory 32, the controller 33, and the user I/F 35 included in the PC 30 have the same configurations as the controller 11, the memory 12, the network I/F 16, and the user I/F 17, respectively, of the MFP 30, and thus the description of these constituent components of the PC 30 is omitted.

The memory 32 stores OS 40 and a browser 41. The browser 41 is capable of causing the display 34 to display an image corresponding to web page data transmitted from the MFP 10, under the control of the controller 33.

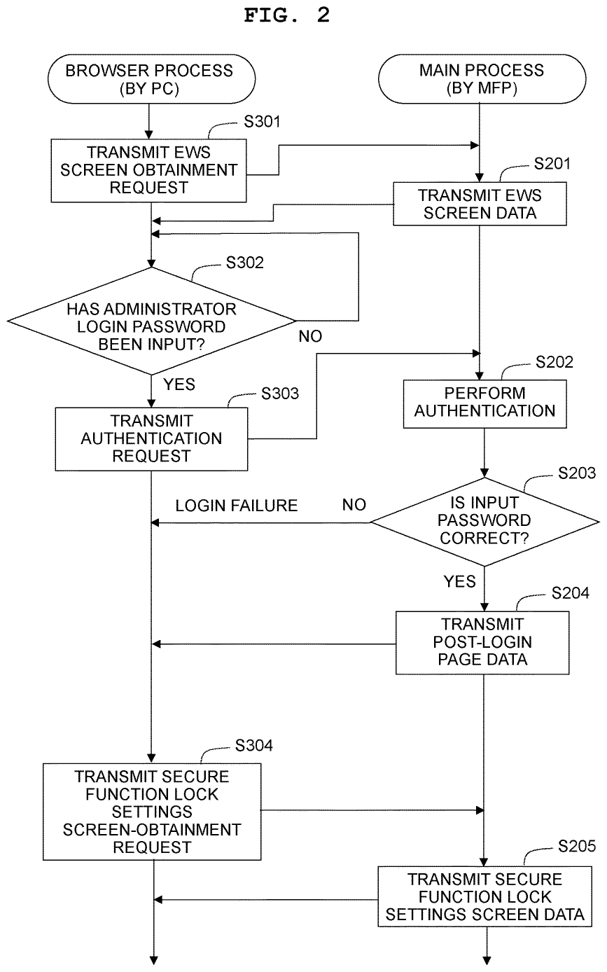

In the following, a control process performed by the image forming system 100 configured as described above will be described in detail, with reference to FIGS. 2 to 18.

FIG. 2 illustrates an example of a procedure in which the PC 30 obtains secure function lock settings screen data from the MFP 10. Hereafter, in the description of each process of the procedure, steps are each denoted as a “step S”.

A browser process in FIG. 2 illustrates a process of the PC 30 starting from a state where the browser 41 is instructed to be launched on the PC 30 and a browser screen is displayed on the display 34 of the PC 30. In response to the URL of the EWS being input in the browser screen by a logged-in user of PC 30, who is, for example, the administrator of the MFP 10, the controller 33 of the PC 30 transmits an EWS screen obtainment request to the MFP 10 (step S301). The EWS is implemented by a process of the controller 11 of the MFP 10. In this situation, a main process in FIG. 2 is a process of the controller 11 serving as the EWS. The main process starts in response to the power of the MFP 10 being turned on.

In response to the controller 11 of the MFP 10 receiving the EWS screen obtainment request from the PC 30, the controller 11 transmits, to the PC 30, EWS screen data in accordance with the request (step S201). The EWS screen data is a kind of the web page data. In response to the controller 33 of the PC 30 receiving the EWS screen data from the MFP 10, the controller 33 causes the display 34 to display a browser screen based on the EWS screen data. In the following, the browser screen based on the web page data will also be referred to simply as “XX screen” or “XX page”. The controller 33 of the PC 30 stands by until an administrator login password is input in a login password input field disposed in the EWS screen (step S302: NO). Then, in response to the administrator login password being input (step S302: YES), the controller 33 transmits an authentication request using the input administrator login password to the MFP 10 (step S303).

In response to the controller 11 of the MFP 10 receiving the authentication request from the PC 30, the controller 11 performs the authentication (step S202), and determines whether the input administrator login password is correct (step S203). In a case where the input administrator login password is incorrect (step S203: NO), the controller 11 performs transmission of page data indicating “login failure” to the PC 30. In a case where the input administrator login password is correct (step S203: YES), the controller 11 transmits post-login page data for the EWS screen to the PC 30 (step S204).

In response to the controller 33 of the PC 30 receiving the post-login page data from the MFP 10, the controller 33 displays a post-login page. The post-login page displays an operation member corresponding to a secure function lock settings screen. In response to the operation member being operated by the administrator, the controller 33 of the PC 30 transmits a secure function lock settings screen-obtainment request to the MFP 10 (step S304).

In response to the controller 11 of the MFP 10 receiving the secure function lock settings screen-obtainment request from the PC 30, the controller 11 transmits, to the PC 30, secure function lock settings screen data in accordance with the request (step S205). In response to the controller 33 of the PC 30 receiving the secure function lock settings screen data from the MFP 10, the controller 33 displays the secure function lock settings screen.

FIG. 3A illustrates an example of the secure function lock settings screen 340. The secure function lock settings screen 340 displays a cancel button 340A, a send button 340B, and radio buttons 340C and 340D. The radio button 340C is a button which is operated so as to disable the secure function lock, i.e., to set the secure function lock to “Off”. The radio button 340D is a button which is operated so as to enable the secure function lock, i.e., set the secure function lock to “On”. The cancel button 340A is a button which instructs to discard the change in the setting performed with respect to the secure function lock settings screen 340. The send button 340B is a button which instructs the transmission, to the MFP 10, of the change in the setting performed with respect to the secure function lock settings screen 340. The radio button 340D is an example of the operation object.

FIG. 3A illustrates the secure function lock settings screen 340 based on the secure function lock settings screen data transmitted from the MFP 10 in which the secure function lock is set to be disabled. On the secure function lock settings screen 340, the radio button 340C is selected. In response to the radio button 340D being selected by the administrator and then the send button 340B being selected by the administrator, the secure function lock having been changed from “disabled” to “enabled” is transmitted from the PC 30 to the MFP 10. In response to this transmission, the controller 11 of the MFP 10 changes the setting value for the secure function lock within the setting value 25 from disabled to enabled. Then, the controller 11 generates screen data of a secure function lock settings screen 340C′ illustrated in FIG. 3B, and transmits the screen data of the secure function lock settings screen 340C′ to the PC 30.

In response to the controller 33 of the PC 30 receiving the screen data from the MFP 10, the controller 33 displays the secure function lock settings screen 340′. The secure function lock settings screen 340′ differs from the secure function lock settings screen 340 in that the radio button 340D is selected. Further, the secure function lock settings screen 340′ differs from the secure function lock settings screen 340 in that the secure function lock settings screen 340′ displays a message “Please perform detailed security settings for the print job.”, and includes additional radio buttons 340E and 340F instructing enablement/disablement of the detailed security settings for the print job.

In response to the radio button 340F being selected by the administrator and then the send button 340B being selected by the administrator, the detailed security settings for the print job having been changed from “disabled” to “enabled” is transmitted from the PC 30 to the MFP 10. In response to this transmission, the controller 11 of the MFP 10 changes the setting value for the detailed security settings for the print job within the setting value 25 from “disabled” to “enabled”. Then, the controller 11 generates screen data of a secure function lock settings screen 340″ illustrated in FIG. 3C, and transmits the generated screen data to the PC 30. The radio button 340F is also an example of the operation object.

In response to the controller 33 of the PC 30 receiving the screen data from the MFP 10, the controller 33 displays the secure function lock settings screen 340″. The secure function lock settings screen 340″ differs from the secure function lock settings screen 340′ in that the secure function lock settings screen 340″ includes a print job group settings field 341 and a user-permission assignment settings field 342.

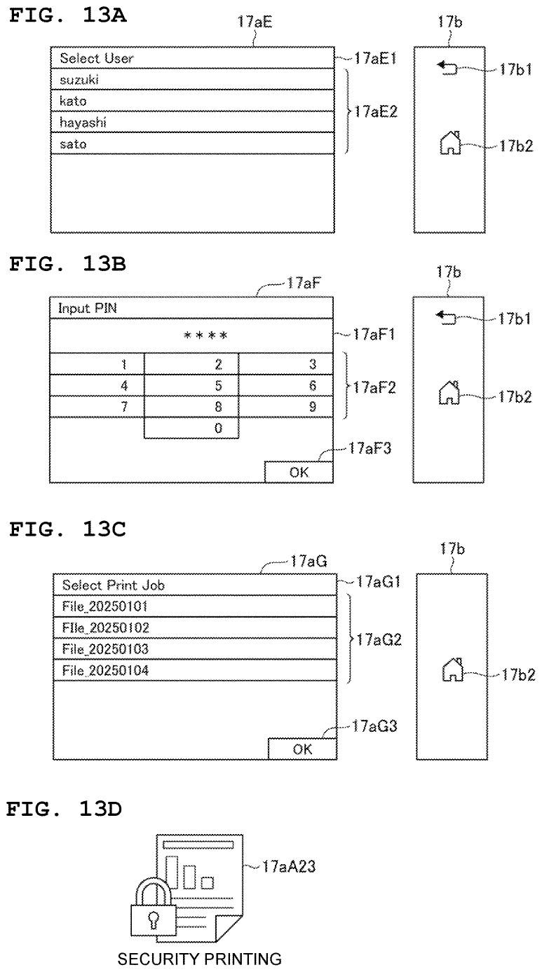

The administrator is capable of operating the print job group settings field 341 to thereby assign group names while associating each of the group names with a corresponding one of permission numbers which are integer values from 1 to 6 in the example illustrated in the drawing. For each of the permission numbers, the administrator is capable of setting permissions each for a corresponding one of the following actions, which are: “print job list display”, “printing”, “deletion from the print job list”, “cancel during reception”, and “cancel during printing”. The “print job list display” means causing the touch panel 17a of the MFP 10 to display, for example, a screen 17aG illustrated in FIG. 13C. The “printing” means printing the print job. The “deletion from print job list display” means, for example, deleting a part or all of the print jobs from a print job list display 17aG2 displayed on the screen 17aG, as illustrated in FIG. 13C. The “cancel during reception” means canceling the reception of a print job while the print job is being received. The “cancel during printing” means canceling the printing of a print job or an MFP report while the print job or the MFP report is being printed. Note that in the present embodiment, the MFP report is a report for managing the MFP 10, such as a report notifying the administrator of the toner remaining amount of the MFP 10, the number of printed pages, the usage status of each of the functions, etc.

Permission settings are defined using four symbol letters: “A”, “P”, “W&A”, and “W”. The symbol “A” indicates “Allowed”. The symbol letter “P” indicates “Prohibited”. The symbol letter “W&A” indicates “Warning”. The symbol letter “W” also indicates “Warning”. While the symbol letter “W&A” indicates “Warning then Allowed”, the symbol letter “W” indicates “Warning only, and not allowed after Warning”. The administrator is able to specify one of the four symbol letters to thereby set the permission for the process or operation on the print job. Here, the permission refers to the restriction on the process or operation with respect to the print job. The four symbol letters “A”, “P”, “W&A”, and “W” are examples of “restriction information”. Note that the restriction on the process or operation with respect to the print job is applicable to the person other than the user, not to the user himself or herself.

The administrator is able to operate the user-permission assignment settings field 342 to thereby assign permission to a user capable of logging in to MFP 10. In the present embodiment, the user capable of logging in to the MFP 10 is specified by the user name, and the permission is specified by the permission number. In the secure function lock settings screen 340, “admin”, i.e., the administrator, is assigned permission number “1”; “suzuki” is assigned permission number “3”; and “kato” is assigned permission number “2”. The user name is an example of “user information”.

In this manner, the administrator performs the operations on the print job group settings field 341 and the user-permission assignment settings field 342 on the secure function lock settings screen 340″, then the administrator selects the send button 340B. With this, the setting content of each of the print job group settings field 341 and the user-permission assignment settings field 342 is transmitted from the PC 30 to the MFP 10. In response to the transmission, the controller 11 of the MFP 10 updates, with the new setting content, the setting content of each of the print job group settings field 341 and the user-permission assignment settings field 342, included in the detailed security settings for the print job within the setting value 25.

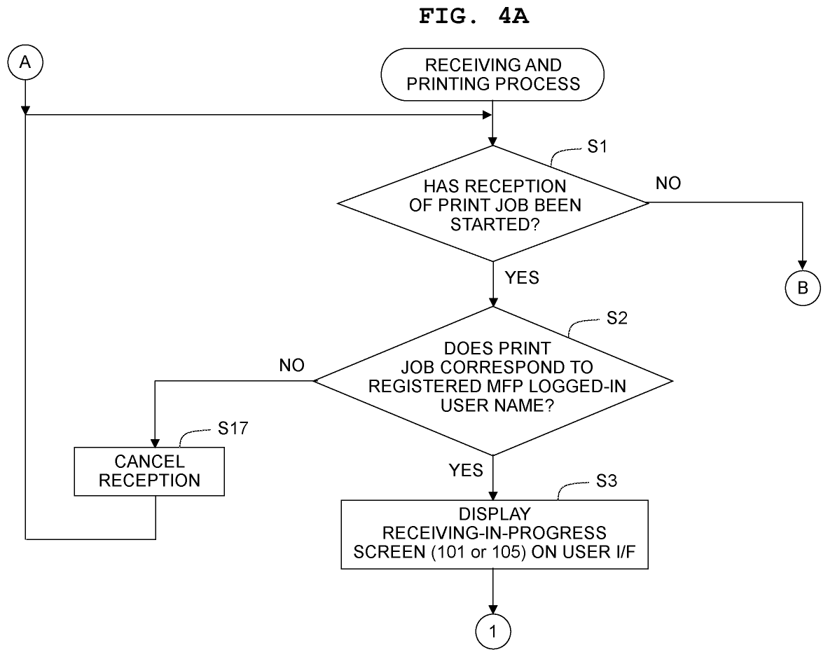

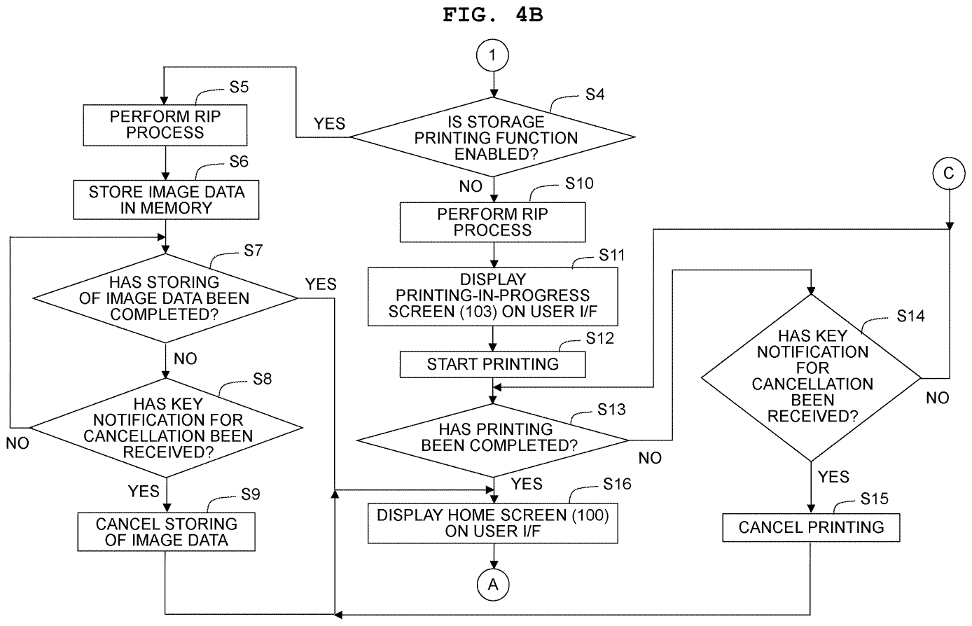

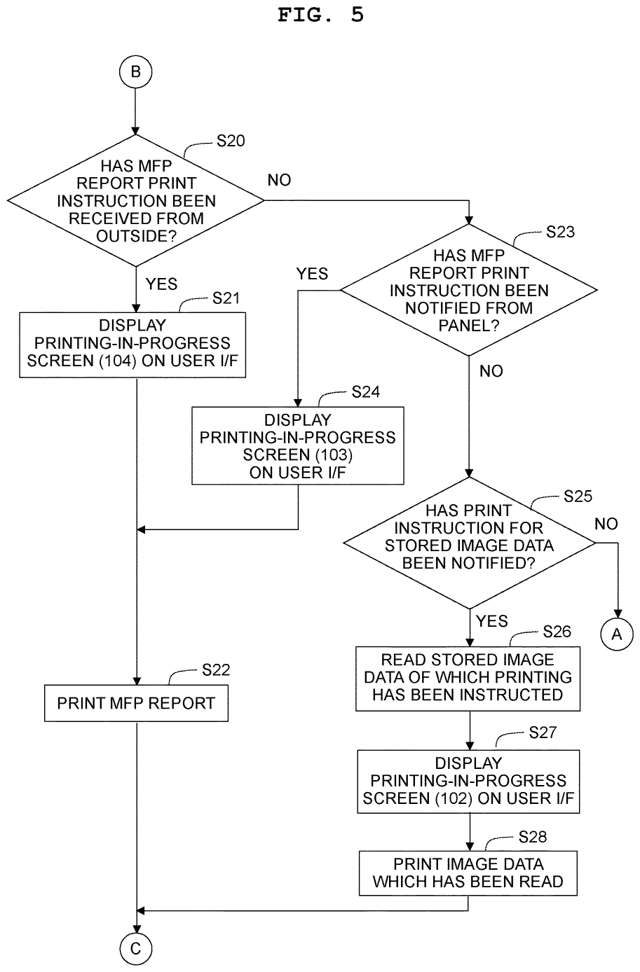

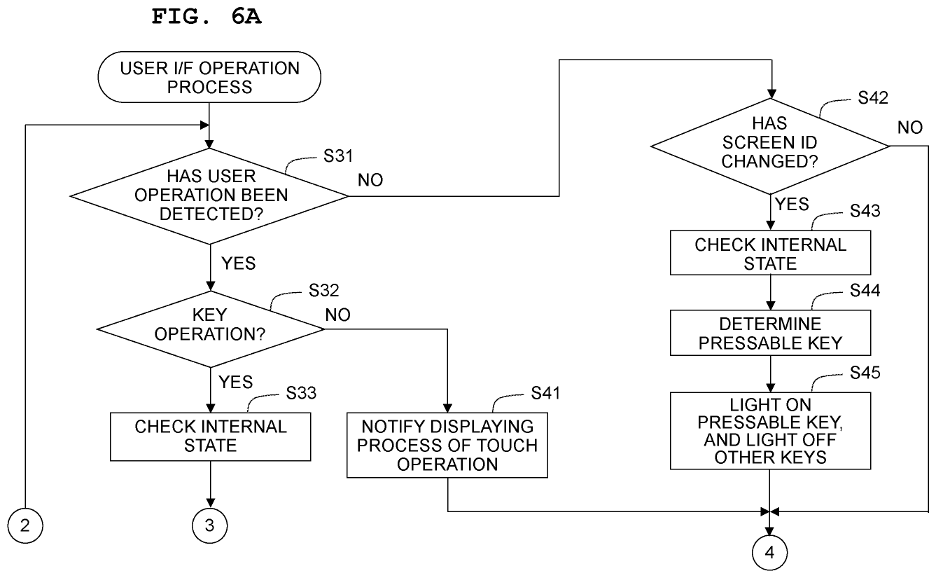

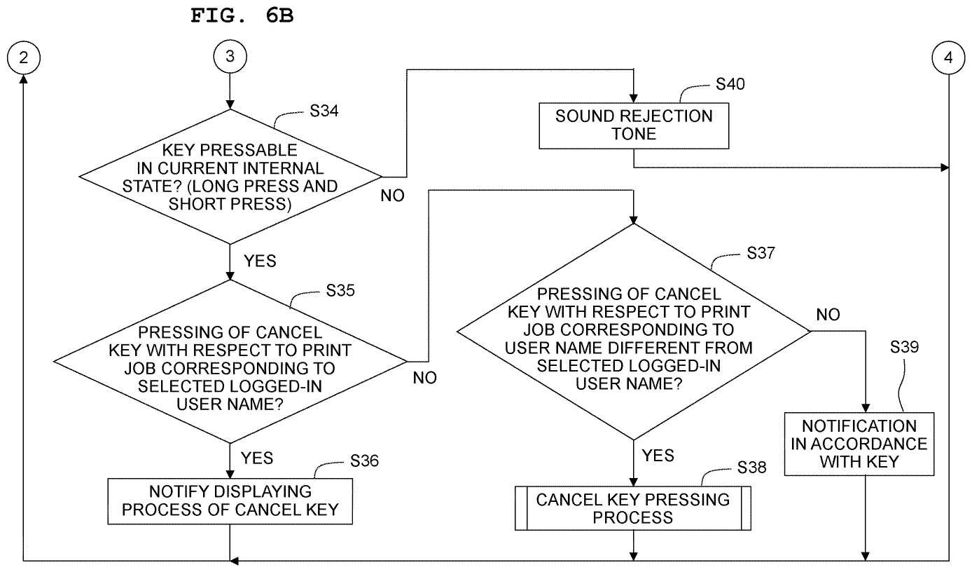

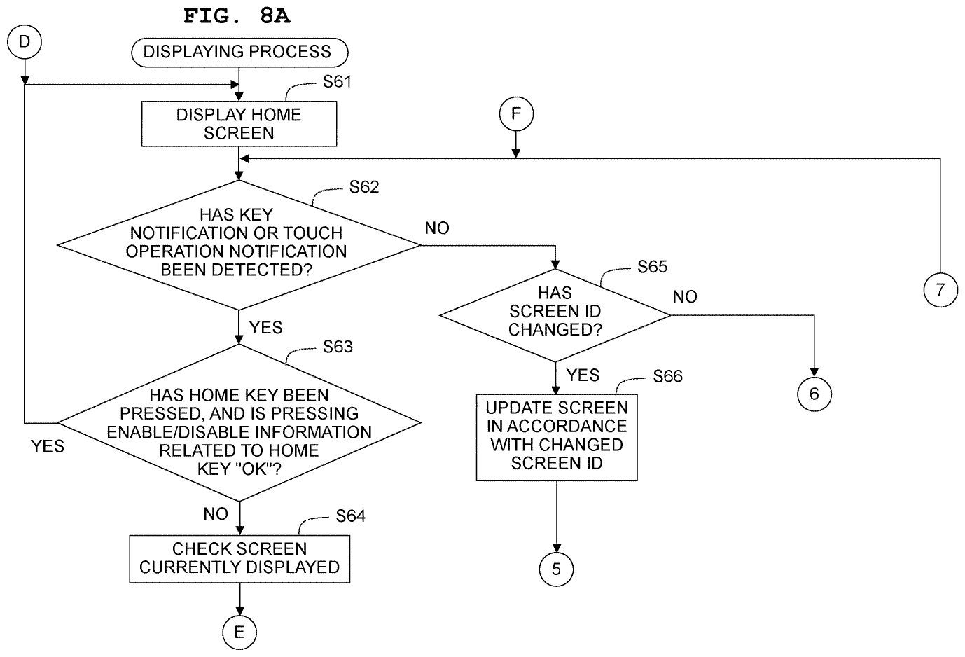

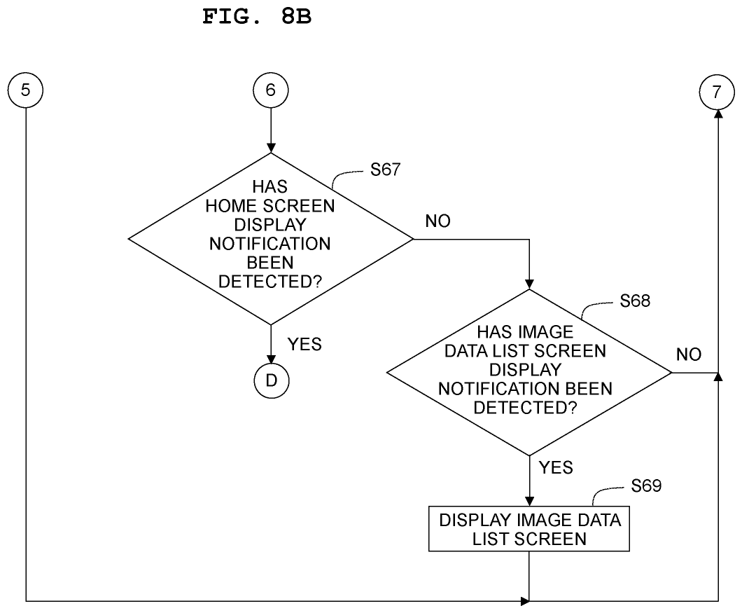

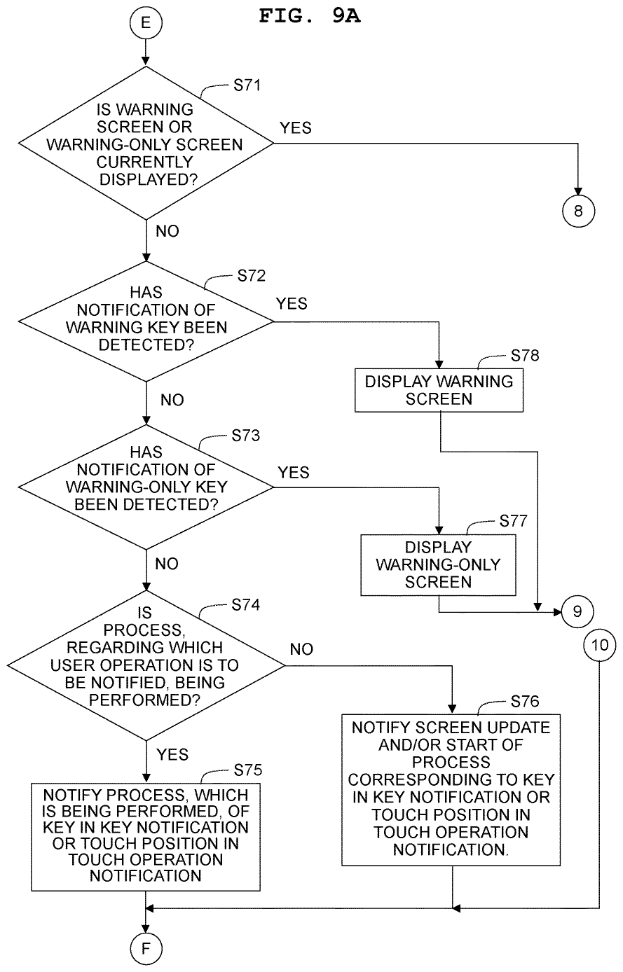

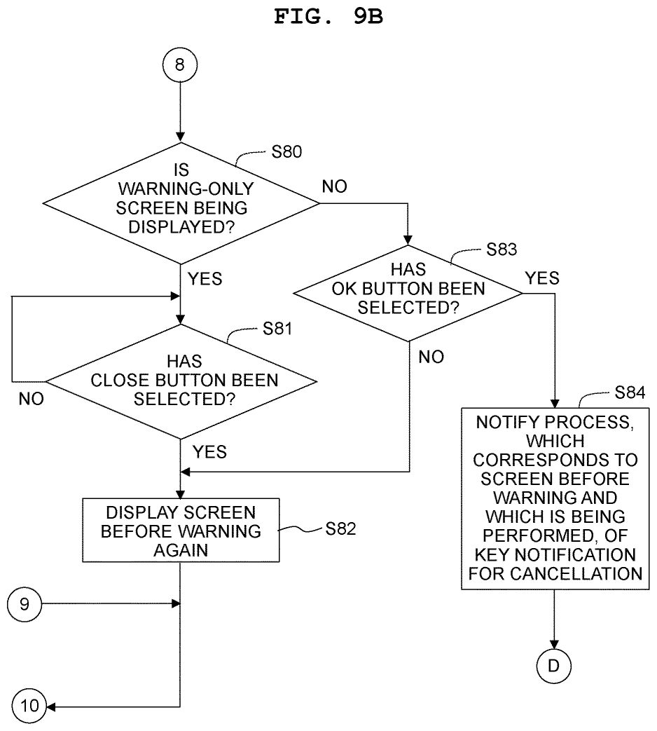

The following description will be made assuming that the secure function lock settings are stored in the memory 12 of the MFP 10 as the setting value 25, in the setting state as illustrated in FIG. 3C. Under this assumption, in response to the power to the MFP 10 being turned on, the controller 11 executes a non-illustrated initialization process, and causes a user I/F operation process illustrated in FIG. 6A and B, a displaying process illustrated in FIGS. 8 and 9, and a receiving and printing process illustrated in FIGS. 4 and 5 to start.

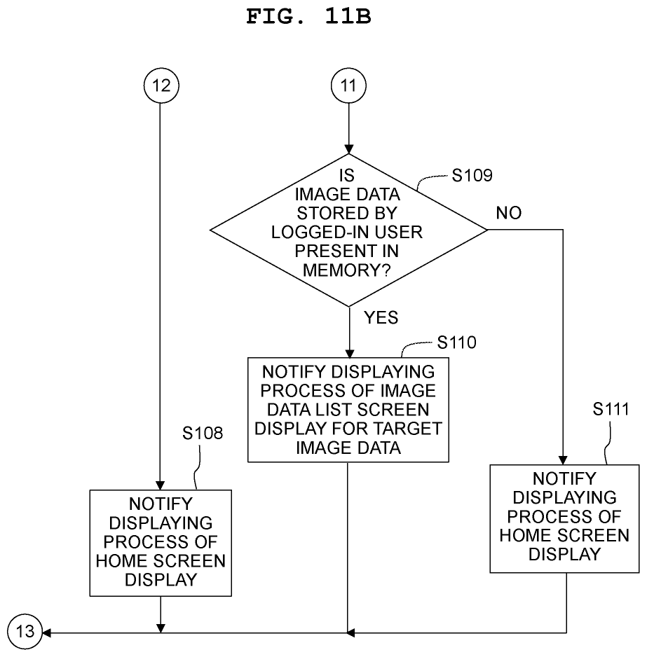

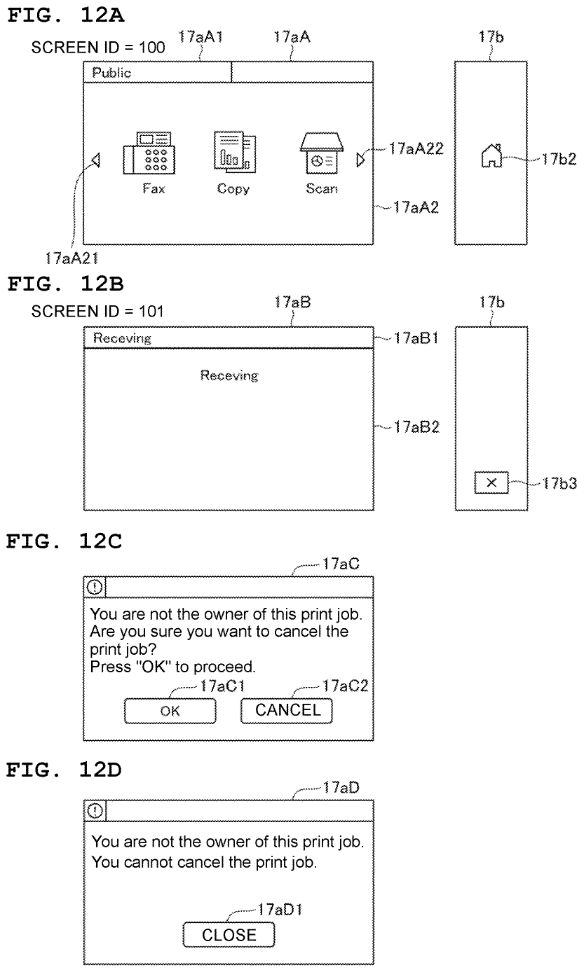

When the displaying process is started, in FIG. 8A, the controller 11 first causes the touch panel 17a to display a home screen (step S61). FIG. 12A illustrates an example of a home screen 17aA (screen ID=100) displayed on the touch panel 17a. The home screen 17aA is composed of a “Public” button 17aA1 and a function selection region 17aA2 for selecting one of the fax function, copying function, and scanning function of the MFP 10. Note that each of the screens displayed on the touch panel 17a is assigned a screen ID. The screen display on the touch panel 17a switches in accordance with the switching of the screen ID. The controller 11 writes the screen ID into a non-illustrated screen ID storage region of the memory 12, during steps such as step S3 in the receiving and printing process which will be described later.

Further, when the user I/F operation process is started, in FIG. 6A, the controller 11 first determines whether a user operation with respect to the user I/F 17 has been detected (step S31). In a case where the user operation has not been detected (step S31: NO), the controller 11 determines whether the screen ID has changed (step S42). In a case where the screen ID has not changed (step S42: NO), controller 11 returns the process to step S31. Then, controller 11 repeats the determinations in step S31 and step S42 until the user operation has been detected (step S31: YES) or until the screen ID has changed (step S42: YES). The user operation with respect to the user I/F 17 includes a touch operation with respect to the touch panel 17a of the user I/F 17, and a key operation with respect to the key input part 17b of the user I/F 17.

For example, in response to the “Public” button 17aA1 being touched and operated when the home screen 17aA is displayed on the touch panel 17a, the controller 11 determines “YES” in the above-described step S31, and then determines whether the user operation is the key operation with respect to the key input part 17b (step S32). The user operation is the touch operation with respect to the touch panel 17a (step S32: NO), and thus the controller 11 notifies the displaying process of the touch operation, namely, the controller 11 performs touch operation notification (step S41). The controller 11 performs the touch operation notification, for example, by causing a non-illustrated touch operation notification storage region of the memory 12 to store information. The information stored in the touch operation notification storage region, as the touch operation notification is, for example, a touch position on the touch panel 17a.

In the above-described displaying process, the controller 11 determines whether a key notification or a touch operation notification has been detected after the process of step S61 (step S62). The controller 11 performs the key notification in, for example, steps such as step S36, which will be described later, in the above-described user I/F operation process. Specifically, the controller 11 performs the key notification by causing a non-illustrated key notification storage region of the memory 12 to store information, similar to the touch operation notification. Note, however, that the information stored in the key notification storage region, as the key notification, differs from the information stored in the touch operation notification; the information stored in the key notification storage region is information identifying which one of the three keys in the key input part 17b has been operated. Thus, since the key notification is stored in the key notification storage region, and the touch operation notification is stored in the touch operation notification storage region, the controller 11 determines, in the above-described step S62, whether the key notification is stored in the key notification storage region or the touch operation notification is stored in the touch operation notification storage region.

In a case where, in step S62, neither the key notification nor the touch operation notification has been detected (step S62: NO), the controller 11 determines whether the screen ID written to the screen ID storage region has changed (step S65). In a case where the screen ID has not changed (step S65: NO), the controller 11 further determines whether a home screen display notification has been detected (step S67). In a case where the home screen display notification has not been detected (step S67: NO), the controller 11 further determines whether an image data list screen display notification has been detected (step S68). In a case where the image data list screen display notification has not been detected (step S68: NO), the controller 11 returns the process to the above-described step S62. In such a manner, after the process in step S61, the controller 11 performs the determinations in steps S62, S65, S67, and S68 repeatedly until the key notification or touch operation notification has been detected (step S62: YES), until the screen ID has changed (step S65: YES), until the home screen display notification has been detected (step S67: YES), or until the image data list screen display notification has been detected (step S68: YES).

Such a case is assumed where, in the display process, while the controller 11 repeatedly performs the determinations in steps S62, S65, S67, and S68, the touch operation of the “Public” button 17aA1 is notified by the process in the above-described step S41. In this assumed case, the controller 11 determines “YES” in step S62, and then determines whether the pressing operation is performed with respect to the home key 17b2 (see FIG. 12A) among the three keys of the key input part 17b, and determines whether the pressing enable/disable information with respect to the home key 17b2 is “OK” (step S63).

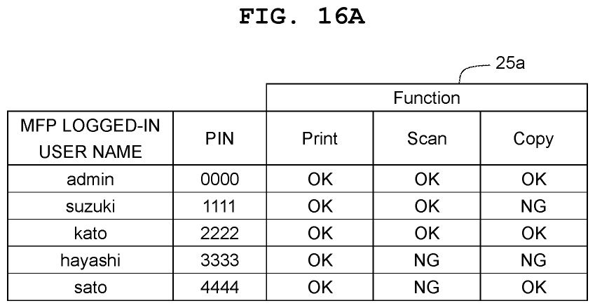

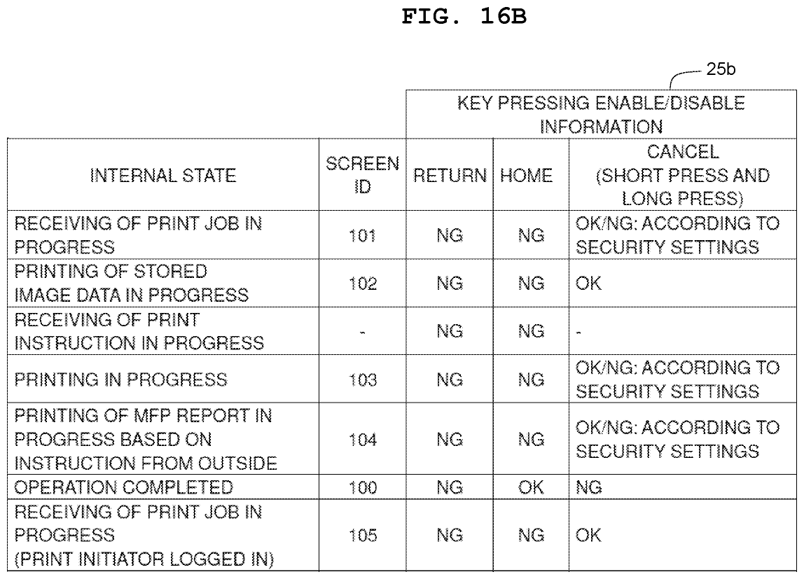

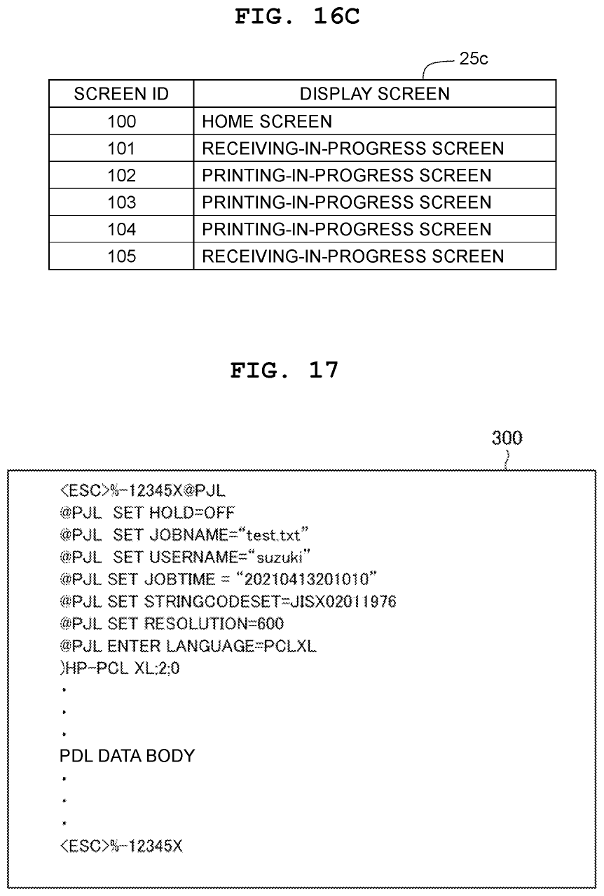

FIG. 16B illustrates an example of table data 25b indicating a screen in accordance with the internal state of the MFP 10, and the key pressing enable/disable information. The table data 25b is composed of the internal state of the MFP 10, the screen ID, and key pressing enable/disable information. The screen ID is an ID identifying a screen displayed on the touch panel 17a of the user I/F 17 in the specific internal state. The key pressing enable/disable information is information specifying whether the three keys included in the key input part 17b of the user I/F 17 in the specific internal state are to be enabled (indicated as “OK” in FIG. 16B) or disabled (indicated as “NG” in FIG. 16B), specifically, whether a return key 17b1, a home key 17b2, and a cancel key 17b3 in the specific state are to be enabled or disabled. The table data 25b is registered, for example, as the setting value 25 in the memory 12. Note that in a case where the internal state of the MFP 10 is “Receiving print instruction in progress”, the screen ID does not exist (—), since the time during which the internal state of the MFP 10 is the state of “Receiving print instruction in progress” is very short, and thus the need for switching the screen of the touch panel 17a to the “Receiving print instruction in progress” screen is low. Of course, the present disclosure is not limited to this configuration, and a screen ID specifying the “Receiving print instruction in progress” screen may be defined, and the “Receiving print instruction in progress” screen may be displayed. Further, as illustrated in FIG. 16C, the display screen data 25c is also stored in the memory 12, while being associated with each of the screen IDs.

The internal state of the MFP 10 is determined as follows: first, a plurality of internal states is previously defined, and then the controller 11 selects an internal state matching the current state from the plurality of internal states previously defined, and causes the memory 12 to store, for example, information indicating the internal state in a non-illustrated internal state storage region of the memory 12. Therefore, the internal state of the MFP 10 means the internal state where information is stored in the internal state storage region of the memory 12. The controller 11 appropriately performs writing of information indicating the internal state to the internal state storage region of the memory 12, in a case where the internal state needs to be switched from the current internal state to another internal state.

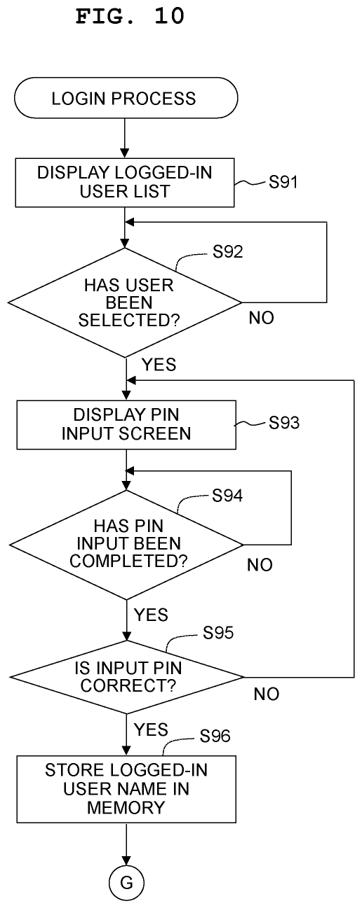

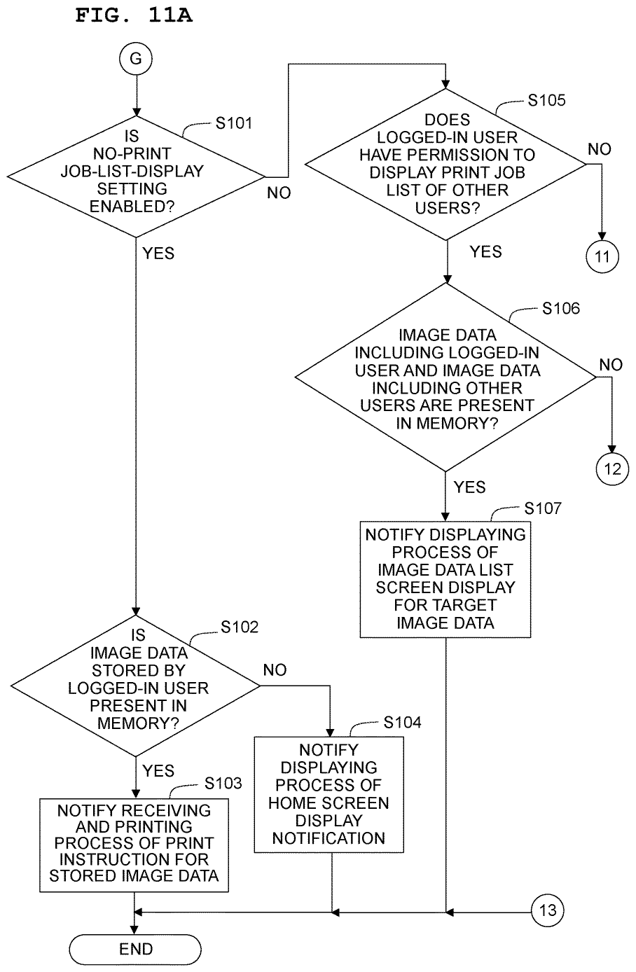

Returning to FIG. 8A, since the touch operation notification has been detected, rather than the key notification, the controller 11 determines “NO” in the above-described step S63, and checks the screen currently displayed (step S64). Specifically, the controller 11 checks the screen ID written in the screen ID storage region as described above. The controller 11 then determines whether a warning screen or a warning-only screen is currently displayed, based on the checked screen (step S71 in FIG. 9A). Since the home screen is currently displayed, and neither the warning screen nor the warning-only screen is displayed, the controller 11 determined “NO” in step S71. Further, since neither a notification of warning key nor a notification of warning-only key is detected, the controller 11 determines “NO” in step S72, and determines “NO” also in step S73. The controller 11 then determines whether a process regarding which the user operation is to be notified is currently being performed (step S74). The controller 11 determines “NO” in a case where the screen ID checked in step S64 is 100, whereas the controller 11 determines “YES” in a case where the screen ID checked in step S64 is any one of 101 to 105. That is, in a case where the screen ID is any one of 101 to 105, the controller 11 determines that the receiving and printing process (FIGS. 4 and 5) is being performed as the process regarding which the user operation is to be notified. Since the screen ID is currently 100, and thus the controller 11 determines “NO” in step S74, and notifies screen update and/or start of process in accordance with the key in the key notification or the touch position in the touch operation notification (step S76). Since the touch operation with respect to the “Public” button 17aA1 instructs the start of a login process illustrated in FIGS. 10 and 11, the controller 11 performs the screen update in accordance with the touch position and also notifies the start of the login process in step S76.

In accordance with the process of step S76, the controller 11 starts the login process illustrated in FIGS. 10 and 11, wherein the controller 11 first causes the touch panel 17a to display a logged-in user list (step S91).

FIG. 13A illustrates an example of a user selection screen 17aE displayed on the touch panel 17a. The user selection screen 17aE includes a display region 17aE1 via which user selection can be instructed (e.g., a “Select User” display) and a user list display region 17aE2 displaying a user list. The operator of the MFP 10 can proceed to login authentication by selecting his or her user name from the users displayed in the user list display region 17aE2.

FIG. 16A illustrates an example of a user DB 25a for login management and functional restriction management. Note that the term “DB” is an abbreviation for database. The user DB 25a is generated, for example, by the administrator managing the MFP 10 and stored in the memory 12 of the MFP 10. The user DB 25a is composed of fields which are MFP Logged-in User name, a PIN, and Function.

The “MFP Logged-in User name” is a user name used when the user logs in to the MFP 10. In the above-described step S91, the user list displayed on the touch panel 17a is a list of MFP Logged-in User names registered in the user DB 25a.

The “PIN” is an abbreviation for a personal identification number, commonly referred to as a passcode. The PIN is previously registered in conjunction with the MFP Logged-in User name, and is used during the login authentication to log in to the MFP 10.

The “Function” is the information for the functional restriction management, and indicates whether the user whose MFP Logged-in User name is registered can use the printing function, the scanning function, and the copying function which are indicated in FIG. 16 as Print, Scan, and Copy, respectively. That is, a user whose MFP Logged-in User name is registered can use a function for which “OK” is registered, but cannot use a function for which “NG” is registered. For example, the user whose MFP Logged-in User name is “suzuki” can use the printing function and the scanning function of the MFP 10, but cannot use the copying function of the MFP 10 when the user is logged in to the MFP 10.

Returning to FIG. 10, the controller 11 stands by until, for example, any user is selected from among the users displayed in the user list display region 17aE2 (step S92: NO). Then, in response to a user being selected (step S92: YES), the controller 11 causes the touch panel 17a to display a PIN input screen (step S93). FIG. 13B illustrates an example of a PIN input screen 17aF. The PIN input screen 17aF includes a PIN input region 17aF1, a numeric keypad display region 17aF2, and an OK button 17aF3.

Next, the controller 11 stands by until the PIN input has been completed (step S94: NO). In response to the PIN input being completed (step S94: YES), the controller 11 determines whether the input PIN is correct (step S95). Whether the PIN input has been completed in step S94 may be determined by checking whether the numeric keypad displayed in numeric keypad display region 17aF2 has been touched to thereby input the PIN into PIN input region 17aF1, and whether the OK button 17aF3 has been touched.

In a case where the controller 11 determines in step S95 that the input PIN is correct (step S95: YES), the controller 11 causes the memory 12 to store the logged-in user name, i.e., the selected MFP Logged-in User name (step S96). Then, the controller 11 determines whether no-print job list-display setting has been set (step S101 in FIG. 11A). The no-print job-list-display setting is a setting not to cause the screen 17aG of the touch panel 17a to display the print job list illustrated in FIG. 13C. The no-print job-list-display setting can be registered in memory 12 as the setting value 25.

In a case where the controller 11 determines in step S101 that the no-print job list-display setting is set (step S101: YES), the controller 11 determines in step S102 whether the image data stored by the logged-in user is present in the memory 12 (step S102). In the following description, the selected MFP Logged-in User name is referred to as a “selected Logged-in User name”. The controller 11 determines whether image data associated with the MFP Logged-in User name matching the selected Logged-in User name is stored. In step S6 illustrated in FIG. 4B, the controller 11 causes the memory 12 to store the image data while associating the image data with the MFP Logged-in User name indicating the user who has transmitted a print job based on which the image data has been generated. This procedure will be described in detail later.

In a case where the controller 11 determines in step S102 that the image data stored by the logged-in user, i.e., the user indicated by the selected Logged-in User name, specifically, the image data based on a print job containing the selected Logged-in User name and stored in the memory 12 in the receiving and printing process, which will be described later, is present in the memory 12 (step S102: YES), the controller 11 notifies the receiving and printing process of the print instruction for the stored image data (step S103), and then ends the login process.

Note that when the process proceeds from step S102 to step S103, the image data stored by the logged-in user is stored as a plurality of image data, in some cases. In this case, the controller 11 may be configured to print all the plurality of image data.

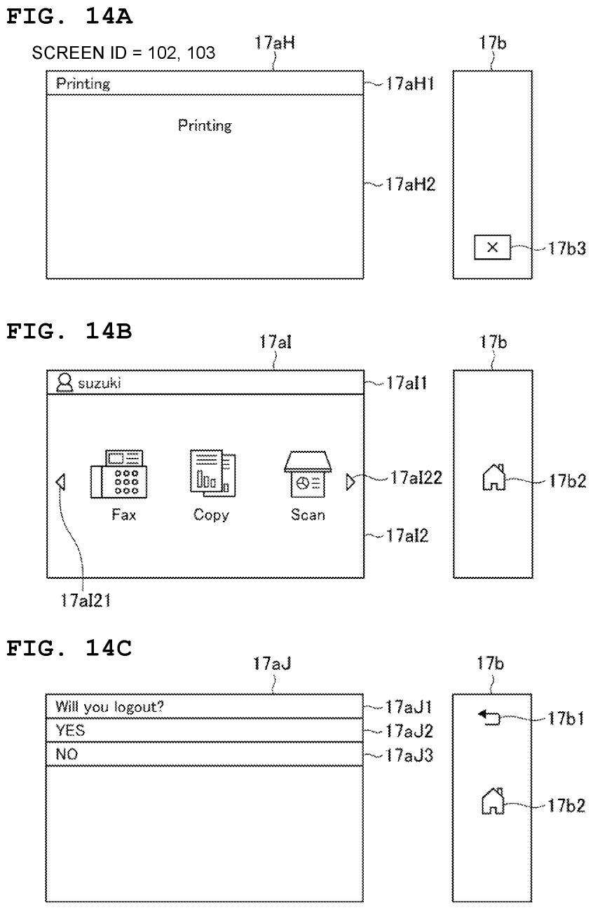

On the other hand, in a case where the controller 11 determines in step S102 that the image data stored by the logged-in user is not present in the memory 12 (step S102: NO), the controller 11 notifies the displaying process of the home screen display notification (step S104), and then ends the login process. In the above-described step S67 of the displaying process (FIG. 8B), in a case where the controller 11 detects the home screen display notification (step S67: YES), the controller 11 returns the process to the above-described step S61, and causes the touch panel 17a to display the home screen (step S61). In this situation, the controller 11 determines whether the selected Logged-in User name is stored in the memory 12. In a case where the selected Logged-in User name is stored in the memory 12, the controller 11 causes the touch panel 17a to display a logged-in home screen. FIG. 14B illustrates an example of a logged-in home screen 17aI displayed on the touch panel 17a. The logged-in home screen 17aI includes a display region 17aI1 displaying the selected Logged-in User name, and a function selection region 17aI2. In response to the selected Logged-in User name displayed in the display region 17aI1 of the logged-in home screen 17aI being touched and operated, the controller 11 causes the touch panel 17a to display a logout confirmation screen.

FIG. 14C illustrates an example of a logout confirmation screen 17aJ. The logout confirmation screen 17aJ includes a display region 17aJ1 which displays a message “Will you logout?”, a YES selection region 17aJ2 for selecting YES, and a NO selection region 17aJ3 for selecting NO. In response to the YES selection region 17aJ2 being touched and operated by the user to thereby perform the logout operation, the controller 11 deletes the selected Logged-in User name stored in the memory 12. Then, the controller 11 switches the screen of the touch panel 17a from the logout confirmation screen 17aJ illustrated in FIG. 14C to the home screen 17aA illustrated in FIG. 12A as described above.

Returning to FIG. 11A, in a case where the controller 11 determines in step S101 that the no-print job list-display setting has not been set (step S101: NO), the controller 11 determines whether the logged-in user has permission to display the print job list of a person other than the user (step S105). The permission to display the print job list is set for each of the groups in the print job group settings field 341 illustrated in FIG. 3C. For example, in a case where the logged-in user is “suzuki”, the permission number 3 is assigned. Accordingly, the selected Logged-in User name “suzuki” has the permission to display the print job list. Therefore, in this case, the controller 11 determines “YES” in step S105. Then, the controller 11 determines whether the stored image data including the logged-in user and the stored image data including a user other than the logged-in user, namely, image data based on a print job including the selected Logged-in User name “suzuki”, and image data based on a print job including a user name other than the Logged-in User name “suzuki” which are stored in the memory 12 in the receiving and printing process, are present (step S106). In a case where the stored image data including the logged-in user and the stored image data including the user other than the logged-in user are present (step S106: YES), the controller 11 notifies the displaying process of the image data list screen display for the target image data (step S107). In the displaying process, the controller 11 detects the image data list screen display notification (step S68: YES), and causes the touch panel 17a to display the image data list screen (step S69).

FIG. 13C illustrates an example of an image data list screen 17aG displayed on the touch panel 17a. The image data list screen 17aG includes a display region 17aG1 on which display of instructing a print job, i.e., image data selection (e.g., a display indicated as “Select Print Job”) is performed, an image data list display region 17aG2 on which the image data list is displayed, and an OK button 17aG3. The logged-in user “suzuki” can select image data to be printed from the image data displayed in the image data list display region 17aG2, and then select the OK button 17aG3 to print the selected image data. Subsequently, the controller 11 causes the touch panel 17a to display the home screen. Note that the controller 11 may be configured such that, in response to the image data list screen 17aG being displayed on the touch panel 17a, the controller 11 may immediately print the image data displayed in the image data list display region 17aG2, without performing the operation of selecting the image data to be printed.

Returning to FIG. 11A, in a case where the controller 11 determines in step S106 that the stored image data including the logged-in user and the stored image data including the user other than the logged-in user are not present (step S106: NO), the controller 11 notifies the displaying process of the home screen display (step S108). In the displaying process, the controller 11 detects the home screen display notification (step S67: YES), and displays the home screen (step S61).

On the other hand, in a case where the controller 11 determines in step S105 that the logged-in user does not have the permission to display the print job list of the user other than the logged-in user (step S105: NO), the controller 11 determines whether image data stored by the logged-in user is present (step S109). In a case where the image data stored by the logged-in user is present (step S109: YES), the controller 11 notifies the displaying process of the image data list screen display for the target image data (step S110). In the displaying process, the controller 11 detects the image data list screen display notification (step S68: YES), and causes the touch panel 17a to display the image data list screen (step S69). On the other hand, in a case where the controller 11 determines in step S109 that the image data stored by the logged-in user is not present (step S109: NO), the controller 11 notifies the displaying process of the home screen display (step S111). In the displaying process, the controller 11 detects the home screen display notification (step S67: YES), and displays the home screen (step S61).

Further, the image data list screen 17aG may be displayed on the touch panel 17a, in response to a security printing icon 17aA23 illustrated in FIG. 13D being selected by the logged-in user, rather than through the login process. The security printing icon 17aA23 may be displayed in the function selection region 17aI21 of the logged-in home screen 17aI in response to a left key 17aI21 or a right key 17aI22 displayed in the function selection region 17aI2 of the logged-in home screen 17aI being operated by the logged-in user.

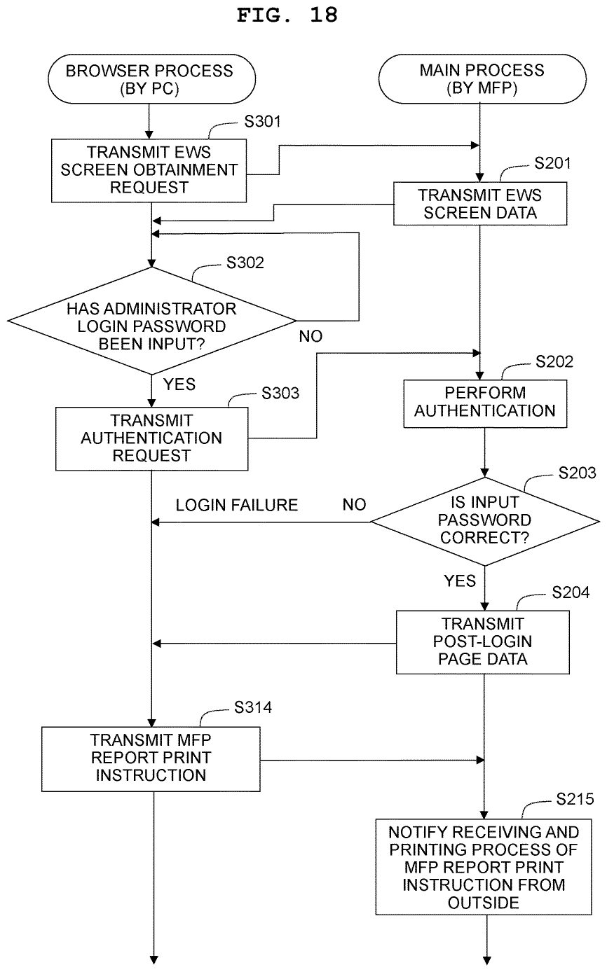

FIG. 18 illustrates the procedure for transmitting an MFP report print instruction from the PC 10 to the MFP 10. As described above, the MFP report is a report for managing the MFP 10, such as a report to inform the administrator of the toner remaining amount of the MFP 10, the number of printed pages, the usage status of each of the functions, etc. The MFP 10 causes the memory 12 to store the information indicating the usage status of each of the functions, as the functions are being performed. The MFP 10 may select information to be printed, in accordance with information included in the MFP report print instruction and indicating which one of the usage statuses of each of the functions is to be printed as the MFP report.

The procedure illustrated in FIG. 18 is the same as the procedure illustrated in FIG. 2 up to step S204. Therefore, in FIG. 18, the steps of the procedure same as the steps of the procedure in FIG. 2 are assigned the same step numbers, and the description of these same steps is appropriately omitted.

In FIG. 18, in response to the PC 10 receiving the post-login page data from the MFP 10, the PC 10 displays the post-login page on the browser screen. The post-login page displays an operation member for transmitting the MFP report print instruction to the MFP 10. In response to the operation member being operated by the administrator, the PC 10 transmits the MFP report print instruction to the MFP 10 (step S314).

In response to the controller 11 receiving the MFP report print instruction from the PC 10, the controller 11 of MFP 10 notifies the receiving and printing process, which will be described next, of the MFP report print instruction from the outside (step S215). Since the MFP report print instruction is notified to the MFP 10 based on the operation by the administrator, the MFP report print instruction can be described as an instruction for the printing associated with the user “administrator”. Further, although the present specification distinguishes the MFP report print instruction from the print job, the MFP report print instruction is an example of the print job. The printing of the MFP report based on the MFP report print instruction is an example of the printing based on the print job. That is, the MFP report print instruction is an example of the print job associated with the user.

FIGS. 4A, 4B and 5 illustrate the procedure of the receiving and printing process. In FIGS. 4A and 4B, the controller 11 first determines whether the reception of the print job has been started (step S1). Specifically, the controller 11 determines whether data is stored in a receiving buffer. In a case where data is stored in the receiving buffer, the controller 11 determines whether the data stored in the receiving buffer is a print job. In a case where the data stored in the receiving buffer is the print job, the controller 11 further determines whether the head of the print job is stored. The receiving buffer is included, for example, in the memory 12 and is a memory region for storing data received from outside the MFP 10 via, for example, the network I/F 16. Note that the data stored in the receiving buffer is not limited to the data from outside the MFP 10; various notifications performed by the controller 11 in the receiving and printing process may also be stored in the receiving buffer. For example, the controller 11 may perform the notification in step S103 (FIG. 11A) by storing, in the receiving buffer, information identifying the target image data to be printed, specifically, information indicating the location at which the image data is stored.

FIG. 17 illustrates an example of the data structure of a print job 300. As illustrated in FIG. 17, the print job 300 is structured with PDL enclosed by PJL. Note that the term “PDL” is an abbreviation for page description language, and the term “PJL” is an abbreviation for printer job language. The head of print job 300 is indicated by “<ESC>%-12345X@PJL”, and the end of print job 300 is indicated by “<ESC>%-12345X”. Therefore, in step S1, in a case where a print job as the target to be received is the print job 300, the controller 11 determines whether the reception of the print job has started based on whether the controller 11 has detected “<ESC>%-12345X@PJL” in the received data. Further, the print job 300 also contains information such as the print job name such as “test.txt”, the user name “suzuki”, and information such as “20210413201010” which is the generation date and time of the print job. Note that the data structure of the print job received by the MFP 10 might differ from the data structure of the print job 300, in some cases. However, for the sake of description in the present embodiment, the MFP 10 is assumed to receive a print job with the same data structure as the print job 300.

Returning to FIG. 4A, in a case where the controller 11 determines in step S1 that the reception of the print job has started (step S1: YES), the controller 11 determines whether the print job corresponds to a registered MFP Logged-in User name (step S2). Specifically, in a case where the user name included in the print job matches any one of the MFP Logged-in User names registered in the user DB 25a (FIG. 16A), the controller 11 determines “YES” in step S2. Note that although the same user might use different user names on the MFP 10 and the PC 10 in some cases, for the sake of convenience, the user is assumed to use the same user name in the present embodiment.

In a case where the controller 11 determines in step S2 that the print job of which reception has been started is the print job corresponding to a registered MFP Logged-in User name (step S2: YES), the controller 11 causes the touch panel 17a of the user I/F 17 to display the receiving-in-progress screen (step S3).

The above-described table data 25b includes two types, indicating, respectively, “Receiving print job in progress” and “Receiving print job in progress (Print initiator logged in)”, as the internal states of the MFP 10 indicating that “Receiving print job in progress”, namely, the print job is being received. Therefore, in a case where the controller 11 determines in step S1 that the reception of the print job has started (step S1: YES), the controller 11 needs to determine whether the current internal state corresponds to which one of the two internal states, before the controller 11 advances the process to the above-described step S2. Namely, the controller 11 determines whether the reception of the print job has started while the print initiator is logged in. In a case where a logged-in user exists, as described in step S76 (FIG. 10) of the login process, the selected Logged-in User name is stored in the memory 12. The controller 11 determines whether the selected Logged-in User name matches the user name contained in the print job. In a case where the controller 11 determines that the selected Logged-in User name matches the user name contained in the print job, the controller 11 writes “Receiving print job in progress (Print initiator logged in)” to the internal state storage region. On the other hand, in a case where the controller 11 determines that the selected Logged-in User name does not match the user name contained in the print job, the controller 11 writes “Receiving print job in progress” to the internal state storage region.

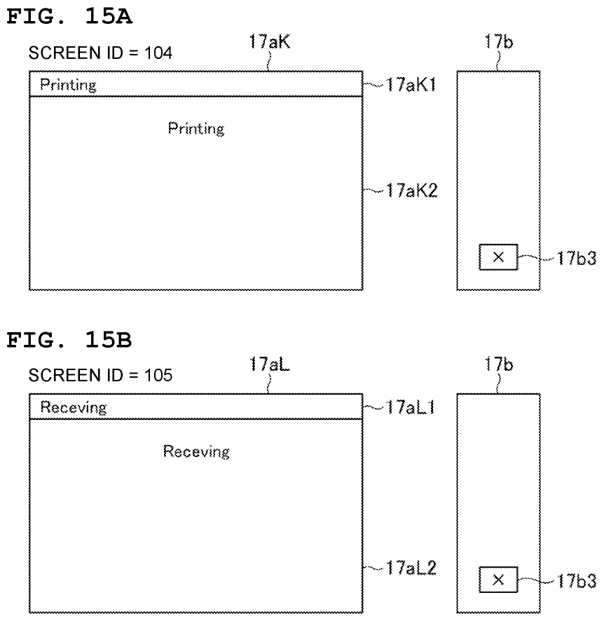

In step S3 in FIG. 4A, the controller 11 causes the touch panel 17 to display the receiving-in-progress screen on the touch panel 17a. Specifically, the controller 11 writes either the screen ID “101” (FIG. 12B) or the screen ID “105” (FIG. 15B) to the screen ID storage region. Here, the controller 11 determines whether to write the screen ID “101” or “105” as the screen ID to the screen ID storage region, based on the internal state of MFP 10. That is, controller 11 refers to the table data 25b as described above; in a case where the internal state of the MFP 10 is “Receiving print job in progress”, the controller 11 writes the screen ID “101” to the screen ID storage region. On the other hand, in a case where the internal state of the MFP 10 is “Receiving print job in progress (Print initiator logged in)”, the controller 11 writes the screen ID “105” to the screen ID storage region.

In the above-described displaying process (FIGS. 8 and 9), in a case where neither the key notification nor the touch operation notification has been detected (step S62: NO), the controller 11 determines whether the screen ID written in the screen ID storage region has changed (step S65). In a case where the screen ID has changed (step S65: YES), the controller 11 reads the display screen data associated with the changed screen ID from the memory 12, and performs the screen update by causing the touch panel 17a to display the display screen data associated with the changed screen ID (step S66).

Furthermore, in the above-described user I/F operation process (FIGS. 6A and 6B), in a case where the user operation has not been detected (step S31: NO), the controller 11 determines in step S42 whether the screen ID written to the screen ID storage region has changed (step S42). In a case where the screen ID has changed (step S42: YES), the controller 11 checks the internal state of the MFP 10 (step S43), and determines in step S44 a key which is pressable, based on the setting content of each of the print job group settings field 341 and the user-permission assignment settings field 342 (step S44). Then, the controller 11 lights on the pressable key, and lights off keys which are different from the pressable key (step S45).

FIG. 12B illustrates an example of a receiving-in-progress screen 17aB (screen ID =101) displayed on the touch panel 17a. The receiving-in-progress screen 17aB includes a display region 17aB1 displaying the internal state of the MFP 10, and a display region 17aB2 displaying the operational state of the MFP 10. FIG. 15B illustrates an example of a receiving-in-progress screen 17aL (screen ID=105) displayed on the touch panel 17a. The receiving-in-progress screen 17aL includes a display region 17aL1 displaying the internal state of the MFP 10 and a display region 17aL2 displaying the operational state of the MFP 10, similarly to the receiving-in-progress screen 17aB. Although the screen IDs differ between the receiving-in-progress screen 17aB illustrated in FIG. 12B and the receiving-in-progress screen 17aL illustrated in FIG. 15B, the display contents of the screens are the same. Further, the lit/unlit state of the three keys 17b1 to 17b3 in the key input part 17b is also the same between FIG. 12B and FIG. 15B. However, screen transition on the touch panel 17a, in response to the cancel key 17b3 which is lit in the key input part 17b being pressed, may differ between FIG. 12B and FIG. 15B, in some cases. The details of this difference will be described later.

Returning to FIG. 4B, the controller 11 next determines in step S4 whether a storage printing function is enabled (step S4). The storage printing function is a function of storing the received print jobs in the memory 12 and then performing printing in response to the user login. In the present embodiment, an example is described wherein a RIP process is performed for the received print job, then the generated image data is stored in the memory 12, and printing is performed in response to the user login (see steps S5 and S6 following step S4). However, the concept of the storage printing function also includes storing the received print job immediately (without performing the RIP process) in the memory and performing printing in response to the user login. The “RIP” is an abbreviation for “raster image processor”. Further, the storage printing function may be set by selecting “enabled” or “disabled”, via the various settings of the MFP 10. Furthermore, the PC 10 may perform the selection setting for enabling or disabling the storage printing function, via the network I/F 16.

In a case where the controller 11 determines in step S4 that the storage printing function is enabled (step S4: YES), the controller 11 performs the RIP process on the print data included in the print job (step S5), and causes the memory 12 to store the image data after the RIP process, in a predetermined memory region of the memory 12, while associating the image data with the user name of the user who has transmitted the print job based on which the image data has been generated (step S6).

Next, the controller 11 determines whether the storing of image data in the memory 12 has been completed (step S7). In a case where the storing of image data in the memory 12 has not yet been completed (step S7: NO), the controller 11 determines whether a key notification for cancellation has been received (step S8). In a case where the key notification for cancellation has not been received (step S8: NO), the controller 11 returns the process to the above-described step S7. On the other hand, in a case where the key notification for cancellation has been received (step S8: YES), the controller 11 cancels the storing of the image data in the memory 12 midway (step S9), and then advances the process to step S16. In step S16, the controller 11 causes the touch panel 17a to display the home screen, similarly to step S61 (FIG. 8A) as described above. Afterward, the controller 11 returns the process to step S1.

Note that in a case where the controller 11 determines that the key notification for cancellation has been received, while the controller 11 is receiving the print job, performing the RIP process on the print job and storing the image data, the controller 11 cancels not only the storing of the image data but also the reception of the print job. Here, in a case where the cancel key 17b3 is pressable (step S34: YES) in the above-described user I/F operation process (FIGS. 6A and 6B), the controller 11 performs the key notification for cancellation in the processes in and after step S35. The control of the key notification for cancellation will be described in the following, based on a related process in each of the user I/F operation process and the displaying process. Note that in a case where the cancel key 17b3 is not pressable (step S34: NO), the controller 11 causes an unillustrated speaker to emit a rejection sound (step S40). The controller 11 may be configured not to emit the rejection sound. Not only in a case where the cancel key 17b3 is pressed but also in a case where any unpressable key is operated, the controller 11 determines “NO” in step S34. For the sake of convenience, the description will be omitted below.

In a case where the controller determines in step S32 in FIG. 6A that the detected user operation is the key operation with respect to the key input part 17b (step S32: YES), the controller 11 checks the internal state stored in the internal state storage region (step S33). Next, the controller 11 refers to the table data 25b (FIG. 16B), and determines whether the key operation is an operation of a key which is pressable in the current internal state (step S34). In the table data 25b, in a case where the current internal state is the “Receiving print job in progress (Print initiator logged in)”, the pressing enable/disable (information) with respect to each of the return key 17b1 and the home key 17b2 of the key input part 17b is indicated as “NG”. However, the pressing enable/disable (information) with respect to the cancel key 17b3 is indicated as “OK”. Therefore, in this case, the controller 11 determines that the key operation with respect to the cancel key 17b3 is the pressable key operation (step S35: YES), and advances the process from step S35 to step S36.

In step S36, the controller 11 notifies the displaying process of the cancel key (step S36), and then returns the process to step S31. In the displaying process notified of the cancel key, the controller 11 notifies the receiving and printing process of the key notification for cancellation (step S62: YES, step S63: NO, step S64, step S71: NO, step S72: NO, step S73: NO, step S74: YES, step S75). In the receiving and printing process, the controller 11 determines that the key notification for cancellation has been received (step S8: YES), and cancels the storing of the image data midway (step S9).

Note that the pressing operation with respect to the cancel key 17b3 includes short press and long press. For example, in a case where the current internal state is “Receiving print job in progress (Print initiator logged in)”, the controller 11 is performing the RIP process and is storing a single print job included in a plurality of jobs transmitted to the controller 11, in some cases. In this situation, in response to the cancel key 17b3 being short-pressed, the controller 11 cancels the storing of the single print job which is currently being stored. On the other hand, in response to the cancel key 17b3 being long-pressed, the controller 11 cancels the reception of the single print job currently being stored and also cancels the reception of any remaining print job(s) newly received while the cancel key 17b3 is being long-pressed. That is, in a case where the controller 11 receives the plurality of print jobs while the cancel key 17b3 is being long-pressed, the controller 11 cancels the reception of the plurality of print jobs. The pressing enable/disable (information) with respect to the cancel key 17b3 in the above-described step S34 (FIG. 6B) is applicable to both the short press and the long press. Note that, as described above, in a case where the controller 11 is storing the image data based on the one received job while receiving the one job, the controller 11 also cancels the reception of the job, regardless of whether the key operation is the short press or the long press.

On the other hand, in a case where the process advances to the above-described step S34 and where the current internal state in the table data 25b is “Receiving print job in progress”, the pressing enable/disable (information) with respect to each of the return key 17b1 and the home key 17b2 in the key input part 17b is indicated as “NG”, similarly to the case where the current internal state in the table data 25b in the table data 25b is “Receiving print job in progress (print initiator logged in)”. However, the pressing enable/disable (information) with respect to the cancel key 17b3 is set in accordance with the security settings. Here, the security settings refer to the secure function lock settings described above based on FIG. 3. Here, the description will be made while assuming that the detailed security settings for the print job illustrated in FIG. 3C is set as the secure function lock settings, as described above.

In a case where the user name of the user currently logged in to the MFP 10, i.e., the selected Logged-in User name, is “suzuki”, the symbol letter “W” is set as the “cancel during reception” setting. Here, the symbol letter “W” indicates, as described above, that only a warning is displayed and the allowance cannot be given after the warning. Since the pressing enable/disable information with respect to the cancel key 17b3 is indicated as “OK”; in this case, in a case where the key operation is for the cancel key 17b3, the controller 11 determines “YES” in step S34. In step S35 following step S34, the controller 11 determines whether the key operation is the pressing of the cancel key 17b3 with respect to the print job corresponding to the selected Logged-in User name (step S35). Since the current internal state of the MFP 10 is “Receiving print job in progress”, the controller 11 determines “NO” in step S35. Accordingly, the controller 11 advances the process from step S35 to step S37. In step S37, the controller 11 determines whether the key operation is pressing of the cancel key 17b3 with respect to the print job corresponding to a User name different from the selected Logged-in User name. The controller 11 determined “YES” in step S37, performs the cancel key pressing process (step S38), and then returns the process to step S31. Note that, in a case where the controller 11 determines that the key operation is not pressing of the cancel key 17b3 (step S37: NO), the controller 11 notifies the pressed key of the displaying process (step S39).

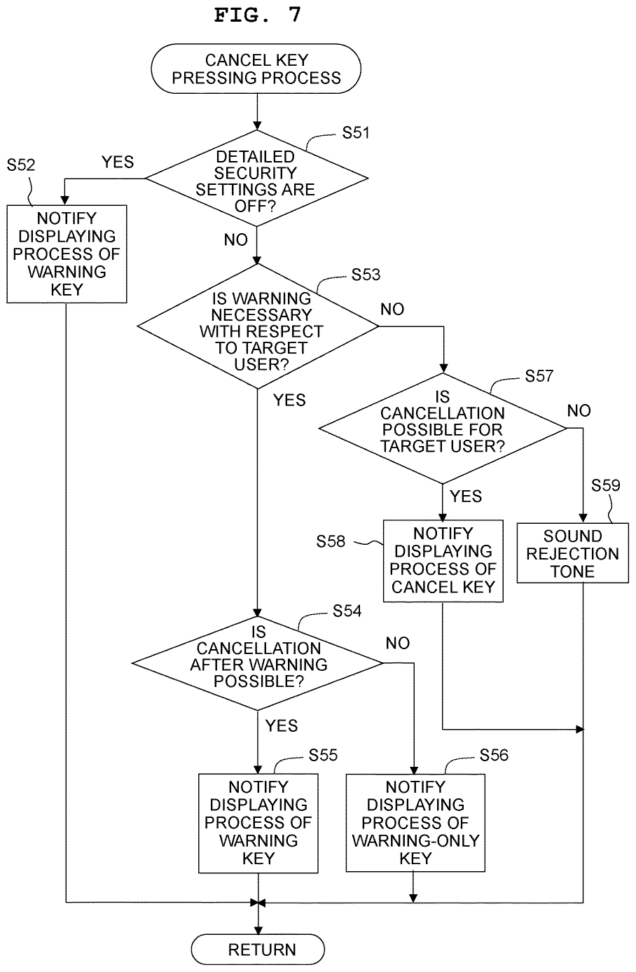

FIG. 7 illustrates the detailed procedure of the cancel key pressing process in step S38. In FIG. 7, in a case where the controller 11 determines in step S51 that the detailed security settings for the print job are Off (step S51: YES), namely, in a case where the controller 11 determines that the setting value 25 contains a setting value corresponding to the selection of the radio button 340E in FIG. 3, the controller 11 notifies the displaying process of the warning key (step S52), and then ends the cancel key pressing process. Accordingly, in step S78 of the displaying process, a warning screen 17aC illustrated in FIG. 12C is displayed. In such a manner, in a case where the detailed security settings for the print job are “Off” (step S51: YES), regardless of whether any one of “A”, “P”, “W&A”, or “W” is set as the “cancel during reception”, the controller 11 performs a process for a case where “W&A” is set, namely, a process of notifying the displaying process of the warning key (step S52).

On the other hand, in a case where the detailed security settings for the print job are “On” (step S51: NO), namely, in a case where the setting value 25 contains a setting value corresponding to the selection of the radio button 340F illustrated in FIG. 3, the controller 11 determines whether the warning is necessary with respect to the target user who is the user indicated by the selected Logged-in User name (step S53). In this situation, since the selected Logged-in User name is “suzuki” and the symbol letter “W” is set as “cancel during reception”, the controller 11 determines “YES” in step S53. Further, in this situation, the controller 11 determines that the cancellation after the warning is not possible (step S54: NO). After notifying the displaying process of the warning-only key (step S56), the controller 11 ends the cancel key pressing process. Accordingly, in step S77 of the displaying process, the warning-only screen 17aD illustrated in FIG. 12D is displayed.

In contrast, in a case where the selected Logged-in User name is “admin”, the selected Logged-in User name “admin” has the symbol letter “W&A” set as the permission with respect to the “cancel during reception” of the print job. Therefore, the controller 11 determines “YES” in step S53, and the controller 11 advances the process to step S54. In step S54, controller 11 determines that for the selected Logged-in User name “admin”, who is the target user, the cancellation after the warning is possible (step S54: YES). After notifying the displaying process of the warning key (step S55), the controller 11 ends the cancel key pressing process. Accordingly, in step S78 of the displaying process, the warning screen 17aC illustrated in FIG. 12C is displayed.

Further, in a case where the selected Logged-in User name is “kato”, the selected Logged-in User name “kato” has the symbol letter “P” set as the permission with respect to the “cancel during reception” of the print job. Therefore, the controller 11 determines “NO” in step S53, and the controller 11 advances the process to step S57. In step S57, controller 11 determines that the cancellation is not possible for the selected Logged-in User name “kato” who is the target user (step S57: NO). After sounding a rejection tone (step S59), the controller ends the cancel key pressing process.

Note that in the print job group settings field 341 illustrated in FIG. 3C, the symbol letter “A” is not set as the permission with respect to the “cancel during reception” of the print job. However, in a case where the symbol letter “A” is set as the permission with respect to the “cancel during reception” of the print job, the controller 11 determines “NO” in step S53, and determines “YES” in step S57. Accordingly, the controller 11 ends the cancel key pressing process after notifying the displaying process of the cancel key (step S58).

In response to the controller 11 notifying the displaying process of the warning key in step S52 or step S55, the controller 11 detects the notification of the warning key in the displaying process (FIG. 9A, step S72: YES), and causes the touch panel 17a to display the warning screen (step S78). FIG. 12C illustrates an example of the warning screen 17aC displayed on the touch panel 17a. The warning screen 17aC displays a warning message: “You are not the owner of this print job. Are you sure you want to cancel the print job? Press “OK” to proceed.” Further, the warning screen 17aC displays an OK button 17aC1 and a cancel button 17aC2. In response to the OK button 17aC1 being selected, the controller 11 notifies the displaying process of the touch operation notification in the user I/F operation process (step S41). The controller 11 detects the touch operation notification in the displaying process (step S62: YES). Since the OK button 17aC1 is operated, the controller determines “NO” in step S63. Since the warning screen rather than the warning-only screen is currently displayed, the controller 11 determines “YES” in step S71, and the controller 11 determines “NO” in step S80. Further, the controller 11 determines “YES” in step S83, the controller 11 notifies the process which corresponds to the screen before the warning and which is being performed, namely, notifies the receiving and printing process, of the key notification for cancellation (step S84), and then the controller 11 causes the touch panel 17a to display the home screen (step S61 in FIG. 8A). In the receiving and printing process, the controller 11 determines that the key notification for cancellation has been received (step S8: YES), and cancels the storing of the image data midway (step S9). On the other hand, in response to the cancel button 17aC2 being selected, the controller 11 determines “NO” in step S83, causes the touch panel 17a to display the screen before the warning (step S82), and then advances the process to step S62 illustrated in FIG. 8A. In this situation, in the receiving and printing process, the controller has not received the key notification for cancellation (step S8: NO), and thus the storing of the image data is completed (step S7: YES). In such a manner, even in a case where the user other than the logged-in user presses the cancel key 17b3 while the controller 11 is receiving the print job for storage printing, the reception of the print job is not immediately canceled. In this manner, the cancellation operation by the user other than the logged-in user can be prevented.

On the other hand, in response to the controller 11 notifying the displaying process of the warning-only key in step S56, the controller 11 detects the notification of the warning-only key in the displaying process (step S73: YES), and causes the touch panel 17a to display the warning-only screen (step S77). FIG. 12D illustrates an example of the warning-only screen 17aD displayed on the touch panel 17a. The warning-only screen 17aD displays a warning message: “You are not the owner of this print job. You cannot perform the cancellation operation”. Further, the warning-only screen 17aD displays a close button 17aD1. In response to the close button 17aD1 being selected, the controller 11 notifies the displaying process of the touch operation notification in the user I/F operation process (step S41). The controller 11 detects the touch operation notification in the displaying process (step S62: YES). Since the close button 17aD1 is operated, the controller determines “NO” in step S63. Since the warning-only screen is currently displayed, the controller 11 determines “YES” in step S71, and the controller 11 determines “YES” in step S80. Further, the controller 11 determines “YES” in step S81, causes the touch panel 17a to display the screen before the warning again (step S82), and then advances the process to step S62 in FIG. 8A. In this situation, in the receiving and printing process, the controller has not received the key notification for cancellation (step S8: NO), and thus the storing of the image data is completed (step S7: YES).

Further, in step S58, in response to the controller 11 notifying the displaying process of the cancel key, in the displaying process, the controller 11 notifies the receiving and printing process of the key notification for cancellation (step S62: YES, S63: NO, step S64, step S71: NO, step S72: NO, step S73: NO, step S74: YES, step S75). In the receiving and printing process, the controller 11 determines that the key notification for cancellation has been received (step S8: YES), and cancels the storing of the image data midway (step S9).

On the other hand, in a case where the controller 11 determines in step S4 that the storage printing function is disabled (step S4: NO), the controller 11 performs the RIP process on the print data contained in the print job (step S10), similarly to step S5. Then, the controller 11 causes the touch panel 17a of the user I/F 17 to display a printing-in-progress screen (step S11). Specifically, the controller 11 writes the screen ID “103” to the screen ID storage region of the memory 12. Note that before the controller 11 performs the process in step S11, the controller 11 writes the “Printing image data in progress” to the above-described internal state storage region. In step S11, the controller 11 refers to the table data 25, and writes the screen ID “103” of a case where the internal state is “Printing in progress” to the screen ID storage region. Accordingly, the printing-in-progress screen is displayed on the touch panel 17a. FIG. 14A illustrates an example of a printing-in-progress screen 17aH (screen ID=102, 103) displayed on the touch panel 17a. The printing-in-progress screen 17aH includes a display region 17aH1 displaying the internal state of the MFP 10, and a display region 17aH2 displaying the operational state of the MFP 10. Further, the controller 11 outputs the image data after the RIP process to the printer 13, thereby starting the printing (step S12).

Next, the controller 11 determines whether the printing has been completed (step S13). In a case where the printing has not been completed (step S13: NO), the controller 11 determines whether the key notification for cancellation has been received (step S14), similarly to the above-described step S8. In a case where the key notification for cancellation has not been received (step S14: NO), the controller 11 returns the process to the above-described step S13. On the other hand, in a case where the key notification for cancellation has been received (step S14: YES), the controller 11 cancels the printing midway (step S15), and then advances the process to step S16. In a case where the printing has been completed (step S13: YES), the controller 11 advances the process to step S16.

The key notification for cancellation received in step S14 is also performed under the control which is similar to the control with respect to the key notification for cancellation received in step S8. However, the key notification for cancellation received in step S8 corresponds to the cancellation during reception of the print job, whereas the key notification for cancellation received in step S14 corresponds to the cancellation during printing of the print job, which is the difference between step S8 and step S14.

In a case where the controller 11 determines in step S32 in FIG. 6A that the detected user operation is the key operation with respect to the key input part 17b (step S32: YES), the controller 11 checks the internal state stored in the internal state storage region (step S33). Next, the controller 11 refers to the table data 25b (FIG. 16B), and determines whether the key operation is an operation of a key which is pressable in the current internal state (step S34). In table data 25b, in a case where the current internal state is “Printing in progress”, the pressing enable/disable (information) with respect to each of the return key 17b1 and the home key 17b2 of the key input part 17b is indicated as “NG”. However, the pressing enable/disable (information) with respect to the cancel key 17b3 is set in accordance with the security settings.

In a case where the current user name logged in to MFP 10, i.e., the selected Logged-in User name, is “suzuki”, the symbol letter “W&A” is set as the cancellation during printing. Here, as described above, the symbol letter “W&A” indicates that the cancellation after the warning is allowed. Therefore, since the pressing enable/disable (information) with respect to the cancel key 17b3 is “OK”, the controller 11 determines “YES” in step S34. In step S35 following step S34, the controller 11 determines whether the key operation is the pressing of the cancel key 17b3 with respect to the print job corresponding to the selected Logged-in User name (step S35). In a case where the key operation is the pressing of the cancel key 17b3 with respect to the print job corresponding to the selected Logged-in User name “suzuki”, the controller 11 determines “YES” in step S35. Then, the controller 11 advances the process from step S35 to step S36, notifies the displaying process of the cancel key (step S36), and then returns the process to the above-described step S31. In the displaying process notified of the cancel key, the controller 11 notifies the receiving and printing process of the key notification for cancellation (step S62: YES, S63: NO, step S64, step S71: NO, step S72: NO, step S73: NO, step S74: YES, step S75). In the receiving and printing process, the controller 11 determines in step S14 that the key notification for cancellation has been received (step S14: YES), and cancels the printing midway (step S15).

On the other hand, in a case where the controller 11 determines in step S35 that the key operation is not the pressing of the cancel key 17b3 for the print job corresponding to the selected Logged-in User name (step S35: NO), the controller 11 advances the process from step S35 to step S37.

In step S37, the controller 11 determines whether the key operation is the pressing of the cancel key 17b3 with respect to the print job corresponding to the user name different from the selected Logged-in User name. In response to the cancel key 17b3 being pressed (step S37: YES), the controller 11 performs the cancel key pressing process (step S38). In FIG. 7, assuming that the detailed security settings for the print job are On (step S51: NO), then in a case where the warning with respect to the target user is necessary (step S53: YES), the controller 11 determines whether the cancellation after the warning is possible (step S54). The symbol letter “W&A” is set, as the permission with respect to the cancellation during reception of the print job for the selected Logged-in User name “suzuki”. Accordingly, the controller 11 determines “YES” in step S53, and the controller 11 determines in step S54 that the cancellation after the warning is possible for the selected Logged-in User name “suzuki” (step S54: YES). Therefore, controller 11 notifies the displaying process of the warning key (step S55).

In contrast, for the selected Logged-in User name “kato”, the symbol letter “P” is set as the permission with respect to the cancellation during printing of the print job. Accordingly, the controller 11 determines “NO” in step S53, and the controller 11 determines in step S57 that the cancellation is not possible for the selected Logged-in User name “kato” who is the target user (step S57: NO). Accordingly, the controller 11 sounds the rejection tone (step S59).

In responses to the controller 11 notifying the displaying process of the warning key in step S55, the controller 11 detects the notification of the warning key in the displaying process (step S72: YES in FIG. 9A), and causes the touch panel 17a to display the warning screen 17aC (step S78). In response to the OK button 17aC1 on the warning screen 17aC being selected, the controller 11 determines “YES” in step S83. After notifying the process which is being performed and which corresponds to the screen before the warning, namely the receiving and printing process, of the key notification for cancellation (step S84), the controller 11 causes the touch panel 17a to display the home screen (step S61 in FIG. 8A). In the receiving and printing process, the controller 11 determines that the key notification for cancellation has been received (step S14: YES), and cancels the printing midway (step S15). On the other hand, in response to the cancel button 17aC2 being selected, the controller 11 determines “NO” in step S83. After causing the touch panel 17a to display the screen before the warning again (step S82), the controller 11 advances the process to step S62 in FIG. 8A. In this situation, in the receiving and printing process, since the controller 11 has not received the key notification for cancellation (step S14: NO), the printing is completed (step S13: YES).

On the other hand, in a case where the controller 11 determines in step S2 that the print job of which reception is started is not a print job corresponding to a registered MFP Logged-in User name (step S2: NO), the controller 11 cancels the reception of the print job without performing the RIP process (step S17), and then ends the receiving and printing process. Note that in step S17, the controller 11 may perform the printing based on the print job, rather than canceling the reception of the print job.

On the other hand, in a case where the controller 11 determines in step S1 that the reception of the print job has not been started (step S1: NO), the controller 11 determines whether the MFP report print instruction has been received from outside the MFP 10 (step S20 in FIG. 5). The controller 11 performs the determination in step S20 also based on whether the MFP report print instruction from the outside is stored in the receiving buffer, specifically, whether the notification (of the MFP report print instruction from the outside) by the above-described step S215 (FIG. 18) has been received. As described above, although the present specification distinguishes the MFP report print instruction from the print job, the MFP report print instruction is an example of the print job. The printing of the MFP report based on the MFP report print instruction is an example of the printing based on the print job.

In a case where the controller 11 determines in step S20 that the MFP report print instruction has been received from outside (step S20: YES), the controller 11 causes the touch panel 17a of user I/F 17 to display the printing-in-progress screen (step S21). Specifically, the controller 11 writes the screen ID “104” to the screen ID storage region of the memory 12. Note that before performing the process in step S21, the controller 11 writes “printing of MFP report in progress based on the instruction from outside” to the above-described internal state storage region. The writing timing is not limited to the above-described timing; the writing timing may also be a timing before or after the controller 11 notifies the receiving and printing process of the MFP report print instruction from outside (step S205), in response to the controller 11 receiving the MFP report print instruction transmitted by the PC 10 in the above-described step S314 (FIG. 18). In step S21, the controller 11 refers to the table data 25b, and writes the screen ID “104” of the case where the internal state is “printing of MFP report in progress based on the instruction from outside” to the screen ID storage region. Thus, the controller 11 performs the process of step S66 of the above-described displaying process to thereby cause the touch panel 17a to display the printing-in-progress screen. FIG. 15A illustrates an example of a printing-in-progress screen 17aK (screen ID=104) displayed on the touch panel 17a. The printing-in-progress screen 17aK is composed of a display region 17aK1 which displays the internal state of the MFP 10, and a display region 17aK2 which displays the operational state of the MFP 10, similarly to the printing-in-progress screen 17aH (FIG. 14A). Next, the controller 11 generates the image data for the specified MFP report, and outputs the image data to the printer 13 to thereby start the printing of the MFP report (step S22), and then the controller 11 advances the process to the above-described step S13 (FIG. 4B).

In response to the printing of the MFP report being instructed from outside, the process proceeds to step S13 after the printing has started. Therefore, the printing of the MFP report can be canceled during printing, similarly to the printing of the print job. The cancellation of the MFP report during printing is performed under a control similar to the control of the cancellation of the print job during printing. Note, however, that since the instruction from outside to print the MFP report is normally given by the administrator, the entity pressing the cancel key 17b3 is not the administrator, but a general user of the MFP 10.

In a case where, in step S32 in FIG. 6A, the detected user operation is the key operation with respect to the key input part 17b (step S32: YES), the controller 11 checks the internal state stored in the internal state storage region (step S33). Next, the controller 11 refers to the table data 25b (FIG. 16B), and determines whether the key operation is the operation of the key which is pressable in the current internal state (step S34). In the table data 25b, in a case where the current internal state is “printing of MFP report in progress based on the instruction from outside”, the pressing enable/disable (information) with respect to each of the return key 17b1 and the home key 17b2 of the key input part 17b is indicated as “NG”. Although the pressing enable/disable (information) with respect to the cancel key 17b3 is set according to the security settings, the print job group settings field 341 does not contain the setting of the permission with respect to the cancellation during printing in a case that the current internal state is “printing of MFP report in progress based on the instruction from outside”. For example, such a case is assumed wherein the symbol letter “W&A” is set with respect to all the owners. In this assumed case, as described above regarding the cancellation during printing, the controller 11 causes the touch panel 17a to display the warning screen 17aC (step S78), in response to the cancel key 17b3 being pressed. In response to the OK button 17aC1 on the warning screen 17aC being selected, the controller 11 determines “YES” in step S83, and the controller 11 notifies the process, which is being performed in accordance with the screen before the warning, namely, the receiving and printing process, of the key notification for cancellation (step S84), and then causes the touch panel 17a to display the home screen (step S61 in FIG. 8A). In the receiving and printing process, the controller 11 receives the key notification for cancellation (step S14: YES), and cancels the printing of the MFP report midway (step S15). On the other hand, in response to the cancel button 17aC2 being selected, the controller 11 determines “NO” in step S83, causes the touch panel 17a to display the screen before the warning again (step S82), and then advances the process to step S62 in FIG. 8A. In this situation, in the receiving and printing process, since the controller 11 has not received the key notification for cancellation (step S14: NO), the printing of the MFP report is completed (step S13: YES).

On the other hand, in a case where, in step S20, the controller 11 has not received the MFP report print instruction from outside (step S20: NO), the controller 11 determines whether the MFP report print instruction has been notified from the user I/F 17 (step S23). The MFP report print instruction can be notified not only from the outside, but also from the touch panel 17a of the user I/F 17. For example, in response to a non-illustrated menu button in the home screen 17aA (FIG. 12A) being touched and operated when the home screen 17aA is displayed on the touch panel 17a, the controller 11 causes the touch panel 17a to display the menu screen. In response to the MFP report print instruction being touched and operated on the menu screen, the controller 11 notifies the receiving and printing process of the MFP report print instruction based on the instruction performed on the panel. Note that the cancellation during the printing based on the MFP report print instruction, based on the instruction performed on the panel, corresponds to the cancellation by the operator himself or herself while operating the MFP 10. Therefore, the cancellation during the printing of the MFP report based on the instruction performed on the panel is allowed, regardless of the setting content in each of the print job group settings field 341 and the user-permission assignment settings field 342, even when the detailed security settings for the print job are set to “On” in the setting value 25. Although the internal state indicating “printing of MFP report in progress based on the instruction performed on the panel” is not stored in the above-described table data 25b, the internal state “Printing in progress” wherein the key pressing enable/disable (information) with respect to the cancel key 17b3 is set to “OK” may be used.

In a case where, in step S23, the MFP report print instruction has been notified from the user I/F 17 (step S23: YES), the controller 11 causes the touch panel 17a of the user I/F 17 to display the printing-in-progress screen (step S24). Specifically, the controller 11 writes the screen ID “103” to the screen ID storage region of the memory 12. Note that before performing the process in step S24, the controller 11 writes “Printing in progress” to the above-described internal state storage region. The writing timing is not limited to the above-described timing; the writing timing may also be a timing which is after the controller 11 has accepted the touch operation with respect to the MFP report print instruction from the above-described menu screen, and which is before or after the controller 11 notifies the receiving and printing process of the MFP report print instruction. In step S24, the controller 11 refers to the table data 25b, and writes the screen ID “103” of the case where the internal state is “Printing in progress” to the screen ID storage region. With this, the controller 11 causes the touch panel 17a to display the printing-in-progress screen by the process in step S60 of the displaying process step as described above. The printing-in-progress screen 17aH illustrated in FIG. 14A serves as both the printing-in-progress screen of which screen ID is “102” and the printing-in-progress screen of which screen ID is “103”. Next, the controller 11 advances the process to the above-described step S22.

In step S22, as described above, the controller 11 generates the image data of the specified MFP report and outputs the image data to the printer 13, thereby starting the printing. Then, the controller 11 advances the process to the step S13 (FIG. 4B). In step S13, the controller 11 determines whether the key notification for cancellation has been received (step S14), until the printing of the MFP report is completed (step S13: NO). In a case where the controller 11 determines in step S14 that the key notification for cancellation has been received (step S14: YES) before the printing of the MFP report is completed (step S13: NO), the controller 11 cancels the printing of the MFP report (step S15). On the other hand, in a case where the controller 11 determines in step S13 that the printing of the MFP report is completed (step S13: YES), without receiving the key notification for cancellation (step S14: NO), the controller 11 advances the process to step S16.

In a case where the cancel key 17b3 is pressable (step S4: YES) in the user I/F operation process (FIGS. 6A and 6B) as described above, the key notification for cancellation received in step S14 is performed in processes in and after step S35. In step S35, the controller 11 determines that the pressing of the cancel key 17b3 is pressing of the cancel key 17b3 with respect to the printing of the MFP report corresponding to the selected Logged-in User name (step S35: YES). After notifying the displaying process of the cancel key (step S36), the controller 11 returns the process to the above-described step S31. In the displaying process notified of the cancel key, the controller 11 notifies the receiving and printing process of the key notification for cancellation (step S62: YES, S63: NO, step S64, step S71: NO, step S72: NO, step S73: NO, step S74: YES, step S75). In the receiving and printing process, the controller 11 determines that the key notification for cancellation has been received (step S14: YES), and cancels the printing of the MFP report midway (step S15).

On the other hand, in a case where, in step S23, the MFP report print instruction has not been notified from the user I/F 17 during the determination in the above-described step S23 (step S23: NO), the controller 11 determines whether the print instruction for the stored image data has been notified (step S25). The print instruction for the stored image data is notified in step S103 of the login process described above.

In a case where the controller 11 determines in step S25 that the print instruction for the stored image data has been notified (step S25: YES), the controller 11 reads, from the memory 25, the stored image data of which printing has been instructed (step S26), and causes the touch panel 17a of the user I/F 17 to display the printing-in-progress screen (step S27). Specifically, the controller 11 writes the screen ID “102” to the screen ID storage region of the memory 12. Note that before performing the process of step S27, the controller 11 writes “Printing of the stored image data in progress” to the internal state storage region. The writing timing is not limited to the above-described timing; the writing timing may also be a timing which is before or after the controller 11 notifies the receiving and printing process of the print instruction in step S103 (FIG. 11A). In step S27, the controller 11 refers to the table data 25b, and writes the screen ID “102” of the case where the internal state is “Printing of the stored image data in progress” to the screen ID storage region. Accordingly, the printing-in-progress screen of the screen ID “102” is displayed on the touch panel 17a. Next, controller 11 outputs the image data read in step S26 to the printer 13, thereby starting the printing of the image data which has been read (step S28), and then the controller 11 advances the process to the above-described step S13 (FIG. 4B). Note that in a case where the internal state is “Printing of the stored image data in progress”, the pressing enable/disable (information) with respect to the cancel key 17b3 in the table data 25b is “OK”. Therefore, in response to the cancel key 17b3 being pressed while the stored image data is being printed (step S13: NO), the controller 11 notifies the receiving and printing process of the key notification for cancellation, similarly to the case where the internal state is “Receiving print job in progress (Print initiator logged in)”. With this, the controller cancels the printing of the stored image data midway (step S15).

On the other hand, in a case where, in step S25, the print instruction for the stored image data has not been received (step S25: NO), the controller 11 returns the process to step S1 (FIG. 5).

Note that although the “target user” in steps S53 and S57 of the cancel key pressing process in FIG. 7 is defined as the user indicated by the selected Logged-in User name, the present disclosure is not limited to this. The “target user” may also be a user indicated by a user name contained in the print job based on which the image data has been generated. Accordingly, for example, in a case where the cancel key 17b3 is pressed, for example, with respect to a print job which is currently being received, in a state where the target user is not logged in to the MFP 1, the warning screen 17aC or the warning-only screen 17aD can be displayed in accordance with the user indicated by the user name contained in the print job.

As described above, the MFP 10 of the present embodiment is capable of restricting the cancellation, by the user other than the logged-in user, of reception of the print job for the storage printing, printing of the print job, or printing of the MFP report based on the instruction from outside the MFP 10, while the print job for the storage printing is being received, the print job is being printed, or the MFP report is being printed based on the instruction from the outside. Accordingly, any erroneous canceling operation by the user other than the logged-in user can be restricted. Further, the degree of the restriction can also be specified for each of the users, thereby contributing to the increase in usefulness of the MFP 10.

The present disclosure is not limited to the above-described embodiment, and various changes can be made within a range not departing from the spirit of the present disclosure.

In the above-described embodiment, although the MFP 10 is described as an example of the printing apparatus, the printing apparatus is not limited to the MFP 10, and may also be a single-function printer.

In the above-described embodiment, the key input part 17b is configured to include the three keys 17b1 to 17b3, and to be switchable between the lit state and the unlit state with respect to each of the three keys. However, the present disclosure is not limited to this configuration. Three buttons corresponding to the three keys 17b1 to 17b3, respectively, may be displayed on the touch panel 17a, and the three buttons may be controlled to be switchable between a displayed state and a non-displayed state, rather than being controlled to be switchable between the lit state and the unlit state in step S45 as described above.

What is claimed is

1. A printing apparatus comprising:
a user interface; and
a controller,
wherein, in response to a cancellation instruction related to a print job associated with a user being input to the controller via the user interface, the controller is configured to cause the user interface to display a warning in a case where the cancellation instruction does not correspond to the user associated with the print job.

2. The printing apparatus according to claim 1, wherein, in response to a cancellation instruction for printing based on the print job being input to the controller via the user interface, while the printing based on the print job is being performed, the controller is configured to cause the user interface to display the warning in a case where the cancellation instruction for the printing does not correspond to the user associated with the print job.

3. The printing apparatus according to claim 1, further comprising a communication interface, wherein
in response to a cancellation instruction for reception of the print job being input to the controller via the user interface, while the reception of the print job is being performed via the communication interface, the controller is configured to cause the user interface to display the warning in a case where the cancellation instruction for the reception of the print job does not correspond to the user associated with the print job.

4. The printing apparatus according to claim 1, further comprising a communication interface and a memory, wherein
in response to the controller receiving the print job via the communication interface, the controller is configured to:
store the print job in the memory, without performing printing based on the print job; and
cause the user interface to display an option corresponding to the stored print job,
in response to the controller accepting, via the user interface, an operation to select the option, the controller is configured to perform the printing based on the print job corresponding to the selected option, and
in response to a cancellation instruction for the print job being input to the controller via the user interface, while the option corresponding to the stored print job is being displayed on the user interface, the controller is configured to cause the user interface to display the warning in a case where the cancellation instruction for the print job does not correspond to the user associated with the print job.

5. The printing apparatus according to claim 1, wherein
in response to the controller accepting a login operation via the user interface, the controller is configured to be in a logged-in state,
the case where the cancellation instruction does not correspond to the user associated with the print job is a case where the controller is not in the logged-in state when the cancellation instruction is input to the controller via the user interface, or is a case where a logged-in user who has performed the login operation does not match the user associated with the print job although the controller is in the logged-in state, and
in the case where the cancellation instruction does not correspond to the user associated with the print job, the controller is configured to cause the user interface to display the warning.

6. The printing apparatus according to claim 1, further comprising a communication interface and a memory, wherein,
in response to the controller receiving the print job via the communication interface, the controller is configured to:
store the print job in the memory, without performing printing based on the print job; and
cause the user interface to display an option corresponding to the stored print job,
in response to the controller accepting, via the user interface, an operation to select the option corresponding to the stored print job, the controller is configured to perform the printing based on the print job corresponding to the selected option,
the controller is configured to register restriction information indicating restriction on cancellation of the print job in the memory, based on an administrator operation, and
in response to the cancellation instruction being input to the controller via the user interface, the controller is configured to restrict the cancellation of the print job in accordance with the restriction information registered in the memory in the case where the cancellation instruction does not correspond to the user associated with the print job.

7. The printing apparatus according to claim 6, wherein
in response to the controller accepting a login operation via the user interface, the controller is configured to be in a logged-in state,
the controller is configured to register a plurality of user information in the memory based on the administrator operation, each of the plurality of user information indicating a corresponding one of a plurality of users capable of logging in to the printing apparatus,
the controller is configured to register a plurality of restriction information each indicating restriction on the cancellation of the print job in the memory, while associating each of the plurality of user information with the plurality of restriction information, based on the administrator operation,
the case where the cancellation instruction does not correspond to the user associated with the print job is a case where the controller is not in the logged-in state when the cancellation instruction is input via the user interface, or a case where a logged-in user who has performed the login operation does not match the user associated with the print job although the controller is in the logged-in state, and
in the case where the cancellation instruction does not correspond to the user associated with the print job, the controller is configured to restrict the cancellation of the print job in accordance with the restriction information registered in the memory and corresponding to the logged-in user.

8. The printing apparatus according to claim 7, wherein
in response to a cancellation instruction for printing based on the print job being input to the controller via the user interface while the printing based on the print job is being performed, in a case where the controller is not in the logged-in state, or in a case where the logged-in user does not match the user associated with the print job although the controller is in the logged-in state, the controller is configured to:
cause the user interface to display the warning in response to the restriction information registered in the memory and corresponding to the logged-in user indicating display of the warning; and
continue the printing without canceling the printing in response to the restriction information registered in the memory and corresponding to the logged-in user indicating prohibition of the cancellation of the printing.

9. The printing apparatus according to claim 8, wherein the controller is configured to register information in the memory, as the restriction information and based on the administrator operation, the information indicating either the printing can be cancelled via the display screen or the printing cannot be canceled via the display screen after the warning has been displayed on a display screen.

10. The printing apparatus according to claim 7, wherein
in response to a cancellation instruction for reception of the print job being input to the controller via the user interface while the reception of the print job is being performed via the communication interface, in a case where the controller is not in the logged-in state, or in a case where the logged-in user does not match the user associated with the print job although the controller is in the logged-in state, the controller is configured to:
cause the user interface to display the warning in response to the restriction information registered in the memory and corresponding to the logged-in user indicating display of the warning; and
continue the reception of the print job without canceling the reception of the print job in response to the restriction information registered in the memory and corresponding to the logged-in user indicating prohibition of cancellation of the reception.

11. The printing apparatus according to claim 7, wherein
in response to the controller receiving the print job via the communication interface, the controller is configured to:
store the print job in the memory, without performing the printing based on the print job; and
cause the user interface to display the option corresponding to the stored print job,
in response to the controller accepting the operation to select the option via the user interface, the controller is configured to perform the printing based on the print job corresponding to the selected option, and
in response to the cancellation instruction for the stored print job being input to the controller via the user interface while the option corresponding to the stored print job is being displayed on the user interface, in a case where the controller is not in the logged-in state, or in a case where the logged-in user does not match the user associated with the print job although the controller is in the logged-in state, the controller is configured:
to cause the user interface to display the warning in response to the restriction information registered in the memory and corresponding to the logged-in user indicating display of the warning; and
not to cancel the print job in response to the restriction information registered in the memory and corresponding to the logged-in user indicating prohibition of the cancellation of the print job.

12. The printing apparatus according to claim 11, wherein in response to the restriction information registered in the memory and corresponding to the logged-in user indicating prohibition of display of the option, in a case where the user associated with the stored print job does not match the logged-in user, the controller is configured not to cause the user interface to display the option, and not to accept the cancellation of the print job.

13. The printing apparatus according to claim 6, wherein
the controller is configured to enable or disable acceptance of the login operation, based on the administrator operation via an administrator screen, and
the controller is configured to accept, via the administrator screen, an operation related to the administrator operation instructing a content of restriction regarding the cancellation of the print job.

14. The printing apparatus according to claim 13, wherein, in response to the controller accepting the administrator operation for enabling the acceptance of the login operation via the administrator screen, the controller is configured to cause the administrator screen to display an operation object related to the administrator operation instructing the content of the restriction regarding the cancellation of the print job.

15. The printing apparatus according to claim 14, wherein, in response to the controller accepting an operation with respect to the operation object displayed on the administrator screen, the controller is configured to cause the user interface to display a restriction operation acceptance screen for accepting the administrator operation, and to store the restriction information in the memory, based on the administrator operation accepted via the restriction operation acceptance screen.

16. A printing apparatus comprising:
a user interface, and
a controller,
wherein, in response to a cancellation instruction regarding a print instruction of a printing apparatus report based on an administrator operation being input to the controller via the user interface, the controller is configured to cause the user interface to display a warning.
